(19) United States
(12) Patent Application Publication
(10) Pub. No.: US 2026/0221862 A1
(43) Pub. Date: Jul. 30, 2026

(54) POWER CONVERSION DEVICE

(71) Applicant: Panasonic Intellectual Property Management Co., Ltd., Osaka (JP)

(72) Inventors: Satoshi OTSU, Osaka (JP); Ryusuke KANOMATA, Osaka (JP); Shinji UJITA, Osaka (JP); Kenichiro TANAKA, Hyogo (JP)

(21) Appl. No.: 19/147,575

(22) PCT Filed: Nov. 30, 2023
(86) PCT No.: PCT/JP2023/043008

§ 371 Date: Jul. 11, 2025

(30) Foreign Application Priority Data
Feb. 14, 2023 (JP) 2023-021121

(51) Int. Cl. H02M 1/00; H02M 1/08; H02M 3/00; H02M 3/335

(52) U.S. Cl. CPC H02M 1/0058; H02M 1/0009; H02M 1/083; H02M 3/015; H02M 3/33571; H02M 3/33576

(57) ABSTRACT

A power conversion device includes: a first switch and a second switch connected to each other in series; a transformer that includes a primary winding and a secondary winding, where the primary winding is connected to a node at the middle point of the first switch and the second switch; a variable capacitance connected in parallel to one of the first switch and the second switch; and a zero volt switching detection circuit that detects whether the first switch and the second switch are performing zero volt switching, based on a voltage across the first switch. The capacitance value of the variable capacitance is a value in accordance with a detection result obtained by the zero volt switching detection circuit.

### TECHNICAL FIELD

The present invention relates to power conversion devices.

### BACKGROUND ART

Patent Literature (PTL) 1 describes techniques of achieving soft switching (e.g., zero volt switching (ZVS)) by connecting a variable capacitance in parallel to at least one driving switching element that forms a full bridge in a phase-shifted full-bridge type DCDC converter circuit in and changing the capacitance according to the size of a load.

### CITATION LIST

### Patent Literature

[PTL 1] Japanese Unexamined Patent Application Publication No. 2006-158137

### SUMMARY OF INVENTION

With the techniques described in PTL 1, soft switching is achieved by changing a variable capacitance in accordance with a load, but when an input voltage or a switching frequency fluctuates, it is difficult to achieve soft switching. In other words, there is a room for improvement in the techniques described in PTL 1.

A power conversion device according to one aspect of the present disclosure includes: a first switch provided on a first path connecting an input terminal and a ground terminal; a second switch provided on the first path and connected to the first switch in series; a transformer including a primary winding and a secondary winding, where the primary winding is connected to a first node between the first switch and the second switch on the first path; a first variable capacitance connected in parallel to one switch out of the first switch and the second switch; and a first zero volt switching detection circuit that detects whether the first switch and the second switch are performing zero volt switching, based on a voltage across the one switch out of the first switch and the second switch. The capacitance value of the first variable capacitance is a value in accordance with a detection result obtained by the first zero volt switching detection circuit.

It should be noted that these general or specific aspects may be implemented by a system, a method, an integrated circuit, a computer program, or a computer-readable recording medium such as a CD-ROM, or any combination of a system, a method, an integrated circuit, a computer program, or a recording medium.

According to one aspect of the present disclosure, it is possible to provide an improved power conversion device capable of achieving soft switching.

### BRIEF DESCRIPTION OF DRAWINGS

FIG. 1 is a configuration diagram illustrating one example of a power conversion device according to Embodiment 1.

FIG. 2A is a diagram illustrating one example of the variable capacitance of the power conversion device according to Embodiment 1.

FIG. 2B is a diagram illustrating one example of the variable capacitance of the power conversion device according to Embodiment 1.

FIG. 3 is a flowchart illustrating one example of the operation of the power conversion device according to an embodiment.

FIG. 4 is a diagram illustrating an example of an output pattern of a zero volt switching (ZVS) detection circuit in the power conversion device according to Embodiment 1.

FIG. 5A is a diagram illustrating an example of variable capacitance control in the case where the output pattern of the ZVS detection circuit in the power conversion device according to Embodiment 1 is a first pattern.

FIG. 5B is a diagram illustrating an example of variable capacitance control in the case where the output pattern of the ZVS detection circuit in the power conversion device according to Embodiment 1 is a second pattern.

FIG. 6 is a diagram illustrating that soft switching is achieved by controlling the variable capacitance of the power conversion device according to Embodiment 1.

FIG. 7 is a diagram for illustrating the relationship of a switching frequency and an excitation current of the power conversion device according to Embodiment 1.

FIG. 8 is a configuration diagram illustrating one example of a power conversion device according to a variation of Embodiment 1.

FIG. 9 is a configuration diagram illustrating one example of a power conversion device according to Embodiment 2.

FIG. 10 is a configuration diagram illustrating one example of a power conversion device according to a variation of Embodiment 2.

### DESCRIPTION OF EMBODIMENTS

Hereinafter, an embodiment of the present disclosure will be described with reference to the drawings.

It should be noted that the embodiments described below each show a general or specific example of the present disclosure. The numeric values, shapes, materials, elements, arrangement and connection of the elements, steps, an order of steps, etc., indicated in the following embodiments are mere examples, and do not intend to limit the present disclosure.

### Embodiment 1

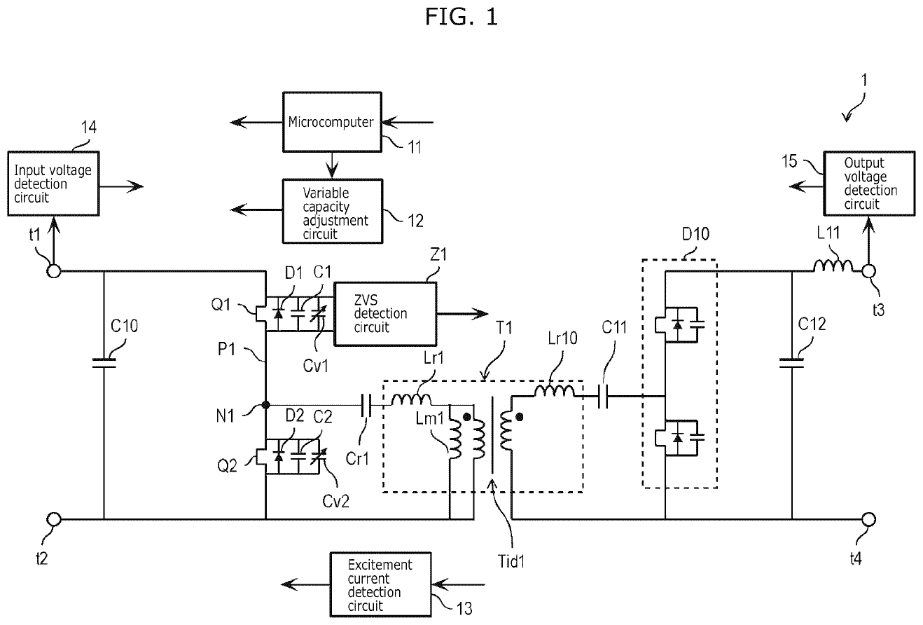

A power conversion device according to Embodiment 1 will be described with reference to FIG. 1 through FIG. 7.

FIG. 1 is a configuration diagram illustrating one example of power conversion device 1 according to Embodiment 1.

Power conversion device 1 is a DCDC converter that increases or decreases an input voltage to a predetermined voltage and outputs the increased or decreased voltage. Power conversion device 1 is, for example, an LLC converter. An LLC converter is a circuit that uses leakage inductance and excitation inductance of transformer T1, and LLC resonance by a resonance capacitor. The LLC converter can output a desired voltage since an input-output voltage ratio (Gain) varies by changing a switching frequency.

There has been an increasing demand for a reduction in the size of power conversion devices, and particularly for a reduction in the sizes of passive components such as inductors and capacitors that occupy the most part of a power conversion device. When reducing the sizes of the passive components, since a current ripple increases if the same driving frequency (switching frequency) as that applied before the size reduction is applied, it is necessary to drive the power conversion device at a high-frequency. In contrast, in a high-frequency drive, since a switching loss occurs each time switching is performed, it is necessary to perform soft switching. For this reason, zero volt switching (ZVS) is performed in power conversion device 1. Specifically, power conversion device 1 performs ZVS by drawing electric charges accumulated in the output capacity of a switch in power conversion device 1 by the excitation current of transformer T1 before the switch is turned on. With this, the output capacity gets closer to 0 when the switch is turned on and a switching loss can be inhibited.

Power conversion device 1 includes terminals t1 through t4. Terminal t1 is one example of the primary-side input terminal of power conversion device 1. Terminal t2 is one example of the primary-side ground terminal of power conversion device 1. Terminal t3 is one example of the secondary-side output terminal of power conversion device 1. Terminal t4 is one example of the secondary-side ground terminal of power conversion device 1. For example, terminal t3 is connected to the secondary winding of transformer T1 via capacitor C11, rectifier circuit D10, and inductor L11.

Power conversion device 1 includes switches Q1 and Q2, variable capacitances Cv1 and Cv2, capacitors Cr1, C10, C11, and C12, inductor L11, rectifier circuit D10, transformer T1, and zero volt switching (ZVS) detection circuit Z1. Power conversion device 1 also includes microcomputer 11, variable capacitance adjustment circuit 12, excitation current detection circuit 13, input voltage detection circuit 14, and output voltage detection circuit 15. It should be noted that power conversion device 1 need not include capacitor C11 or inductor L11.

Switch Q1 is one example of a first switch provided on path P1 connecting terminal t1 and terminal t2. Path P1 is one example of a first path. Switch Q2 is one example of a second switch provided on path P1 and connected to switch Q1 in series.

Switch Q1 is, for example, an N-channel metal oxide semiconductor field effect transistor (MOSFET). In FIG. 1, the parasitic capacity of switch Q1 is shown as capacitor C1, and capacitor C1 is connected to switch Q1 in parallel in an equivalent circuit. The drain of switch Q1 is connected to terminal t1, and the source of switch Q1 is connected to the drain of switch Q2. In FIG. 1, the parasitic diode of switch Q1 is shown as diode D1, and the anode of diode D1 is connected to the source of switch Q1 while the cathode of diode D1 is connected to the drain of switch Q1 in the equivalent circuit.

Switch Q2 is, for example, an N-channel MOSFET. In FIG. 1, the parasitic capacity of switch Q2 is shown as capacitor C2, and capacitor C2 is connected to switch Q2 in parallel in an equivalent circuit. The drain of switch Q2 is connected to the source of switch Q1, and the source of switch Q2 is connected to terminal t2. In FIG. 1, the parasitic diode of switch Q2 is shown as diode D2, and the anode of diode D2 is connected to the source of switch Q2 while the cathode of diode D2 is connected to the drain of switch Q2 in the equivalent circuit.

Transformer T1 includes a primary winding and a secondary winding, and the primary winding is connected to node N1 between switch Q1 and switch Q2 on path P1. Node N1 is one example of a first node. For example, the primary winding of transformer T1 is connected to node N1 via capacitor Cr1, and the secondary winding of transformer T1 is connected to rectifier circuit D10 via capacitor C11. In FIG. 1, the equivalent circuit of transformer T1 is shown and transformer T1 can be presented by ideal transformer Tid1, excitation inductance Lm1 and leakage inductance Lr1 on the primary side as well as leakage inductance Lr10 on the secondary side. Excitation inductance Lm1 is connected to the primary-side coil of ideal transformer Tid1 in parallel, leakage inductance Lr1 is connected to the primary-side coil of ideal transformer Tid1 in series, and leakage inductance Lr10 is connected to the secondary-side coil of ideal transformer Tid1 in series. It should be noted that power conversion device 1 may include an inductor equivalent to leakage inductance Lr1, an inductor equivalent to excitation inductance Lm1, and an inductor equivalent to leakage inductance Lr10.

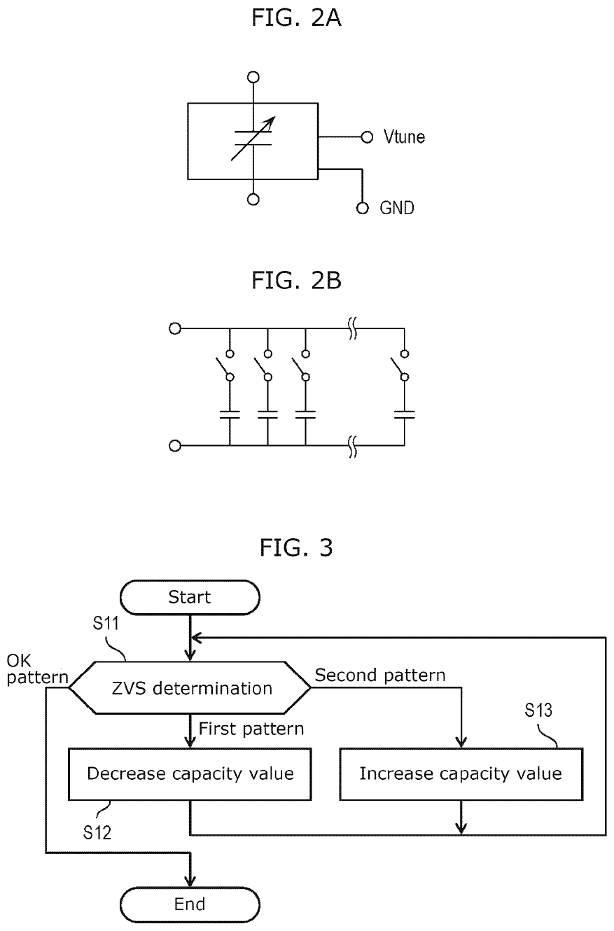

Variable capacitance Cv1 is connected to switch Q1 in parallel and variable capacitance Cv2 is connected to switch Q2 in parallel. It should be noted that power conversion device 1 needs to include a variable capacitance connected to one of switch Q1 and switch Q2 in parallel, and need not include both of variable capacitances Cv1 and Cv2. Examples of realizing a variable capacitance will be described with reference to FIG. 2A and FIG. 2B.

FIG. 2A and FIG. 2B are each a diagram illustrating one example of a variable capacitance.

As illustrated in FIG. 2A, a variable capacitance may include, for example, a control terminal (a terminal to which applied voltage Vtune is applied) for adjusting a capacitance value, and the capacitance value may be controlled in accordance with applied voltage Vtune to the control terminal. In this case, the capacitance value of the variable capacitance is a value in accordance with the applied voltage to the control terminal.

As illustrated in FIG. 2B, a variable capacitance may include: capacitors whose capacitance values are different; and one or more switches that switch a combination of the capacitors, and the capacitance value may be controlled in accordance with the switching control of the one or more switches. In this case, the capacitance value of a variable capacitance is a value in accordance with the combination of the capacitors which is determined by the switching control of the one or more switches.

The capacitance values of variable capacitances Cv1 and Cv2, whose details will be described later, are values in accordance with a detection result obtained by ZVS detection circuit Z1.

The output capacity of switch Q1 is the combined capacity of capacitor C1 and variable capacitance Cv1, and the output capacity of switch Q1 can be adjusted by controlling variable capacitance Cv1. The output capacity of switch Q2 is the combined capacity of capacitor C2 and variable capacitance Cv2, and the output capacity of switch Q2 can be adjusted by controlling variable capacitance Cv2.

ZVS detection circuit Z1 detects whether switches Q1 and Q2 are performing ZVS, based on a voltage across switch Q1 or Q2 (specifically, a drain-source voltage) to which a variable capacitance is connected. In the example in FIG. 1, ZVS detection circuit Z1 detects whether switches Q1 and Q2 are performing ZVS, based on the voltage across switch Q1 to which variable capacitance Cv1 is connected. For example, ZVS detection circuit Z1 is connected to switch Q1 in parallel and detects the voltage across switch Q1. ZVS detection circuit Z1 outputs the detection result to microcomputer 11. The details of ZVS detection circuit Z1 will be described later. Capacitor Cr1 is connected between node N1 and the primary winding of transformer T1. Capacitor Cr1 is a resonance capacitor in an LLC converter.

Capacitor C10 is an input capacitor connected between terminal t1 and terminal t2, and capacitor C12 is an output capacitor (smooth capacitor) connected between terminal t3 and terminal t4.

Inductor L11 is a smooth coil connected to terminal t3.

Rectifier circuit D10 is connected to the secondary winding of transformer T1. Since the primary side of rectifier circuit D10 has a half-bridge configuration, rectifier circuit D10 on the secondary side also has a half-bridge configuration. Capacitor C11 is provided between the secondary winding of transformer T1 and rectifier circuit D10.

Microcomputer 11 is a circuit for controlling switching (on and off) of switches (e.g., switches Q1 and Q2) included in power conversion device 1. For example, microcomputer 11 controls the switching of switches Q1 and Q2 by controlling gate drive circuits (not shown in the figure) connected to the gates of switches Q1 and Q2.

Microcomputer 11 is also one example of a control circuit that controls the capacitance values of variable capacitances Cv1 and Cv2 based on a detection result obtained by ZVS detection circuit Z1. For example, microcomputer 11 controls the capacitance values of variable capacitances Cv1 and Cv2 via variable capacitance adjustment circuit 12. For example, when increasing the capacitance values of variable capacitances Cv1 and Cv2, microcomputer 11 instructs variable capacitance adjustment circuit 12 to increase the present capacitance values of variable capacitances Cv1 and Cv2 by a fixed amount, and when decreasing the capacitance values of variable capacitances Cv1 and Cv2, microcomputer 11 instructs variable capacitance adjustment circuit 12 to decrease the present capacitance values of variable capacitances Cv1 and Cv2 by a fixed amount.

It should be noted that power conversion device 1 may include variable capacitance adjustment circuit 12 for each variable capacitance. In other words, power conversion device 1 may include both variable capacitance adjustment circuit 12 for adjusting variable capacitance Cv1 and variable capacitance adjustment circuit 12 for adjusting variable capacitance Cv2.

Excitation current detection circuit 13 detects an excitation current that flows through excitation inductance Lm1. The excitation current that flows through excitation inductance Lm1 can be obtained by subtracting an output current from transformer T1 from an input current to transformer T1 that flows along the path connecting node N1 and the primary winding of transformer T1 (the path in which capacitor Cr1 is provided). For this reason, excitation current detection circuit 13 may detect an excitation current by, for example, detecting an input current to transformer T1 and an output current from transformer T1.

Input voltage detection circuit 14 detects a voltage input to power conversion device 1. Specifically, input voltage detection circuit 14 detects the voltage of terminal t1. More specifically, input voltage detection circuit 14 detects the voltage between terminal t1 and terminal t2.

Output voltage detection circuit 15 detects a voltage output from power conversion device 1. Specifically, output voltage detection circuit 15 detects the voltage of terminal t3 connected to rectifier circuit D10. More specifically, output voltage detection circuit 15 detects the voltage between terminal t3 and terminal t4.

Next, one example of the operation of power conversion device 1 (microcomputer 11 to be specific) will be described with reference to FIG. 3.

FIG. 3 is a flowchart illustrating one example of the operation of power conversion device 1 according to the embodiment.

First, microcomputer 11 determines whether to decrease, increase, or keep the capacitance values of variable capacitances Cv1 and Cv2 based on the detection result obtained by ZVS detection circuit Z1 (step S11). In FIG. 3, the determination is indicated as ZVS determination. For example, based on a detection result obtained by ZVS detection circuit Z1, microcomputer 11 controls the capacitance value of variable capacitance Cv1 to turn on switch Q1 when a voltage across switch Q1 to which variable capacitance Cv1 is connected is a predetermined threshold voltage or lower, and controls the capacitance value of variable capacitance Cv2 to turn on switch Q2 when a voltage across switch Q2 to which variable capacitance Cv2 is connected is a predetermined threshold voltage or lower.

For example, ZVS detection circuit Z1 has functions of a comparator that compares a voltage across switch Q1 and a predetermined threshold voltage, outputs 1 to microcomputer 11 when the voltage across switch Q1 is higher than the predetermined threshold voltage, and outputs 0 to microcomputer 11 when the voltage across switch Q1 is the predetermined threshold voltage or lower.

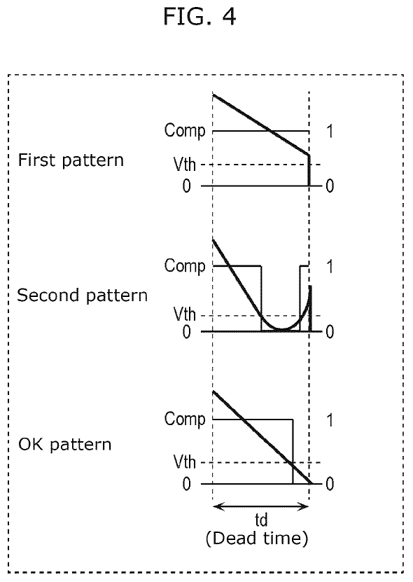

Microcomputer 11 determines the output pattern of ZVS detection circuit Z1 in dead time when switches Q1 and Q2 are both turned off when switches Q1 and Q2 repeat being turned on and off alternately. Specifically, microcomputer 11 determines whether the output pattern of ZVS detection circuit Z1 in the dead time is a first pattern, a second pattern, or an OK pattern (a third pattern). The first pattern, the second pattern, and the OK pattern will be described with reference to FIG. 4.

FIG. 4 is a diagram illustrating examples of an output pattern of ZVS detection circuit Z1. In FIG. 4, Comp (each of the thin solid lines) indicates the output of the comparator, Vth (each of the thin broken lines) indicates a predetermined threshold voltage, and each of the thick solid lines indicates a voltage across switch Q1. In FIG. 4, td denotes dead time.

The first pattern is a pattern in which the voltage across switch Q1 in the dead time is constantly higher than the predetermined threshold voltage, and is a pattern in which the output of ZVS detection circuit Z1 is constantly 1 during the dead time.

The second pattern is a pattern in which the voltage across switch Q1 in the dead time increases again to be higher than the predetermined threshold voltage after decreasing to be the predetermined threshold voltage or lower from the state of being higher than the predetermined threshold voltage, and is a pattern in which the output of ZVS detection circuit Z1 changes from 1, then 0, and to 1 during the dead time.

The OK pattern is a pattern in which the voltage across switch Q1 in the dead time changes from the state of being higher than the predetermined threshold voltage to the state of being the predetermined threshold voltage or lower, and is a pattern in which the output of ZVS detection circuit Z1 changes from 1 to 0 during the dead time.

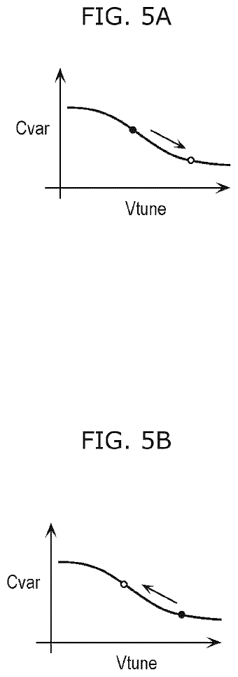

When the output pattern of ZVS detection circuit Z1 is the first pattern (the first pattern in step S11), i.e., when the voltage across switch Q1 is constantly higher than the predetermined threshold voltage, microcomputer 11 controls the capacitance value of variable capacitance Cv1 to decrease the capacitance value of variable capacitance Cv1 (step S12). When an example of realizing variable capacitance Cv1 is the one illustrated in FIG. 2A, for example, microcomputer 11 controls the capacitance value of variable capacitance Cv1, as illustrated in FIG. 5A.

FIG. 5A is a diagram illustrating a control example of variable capacitance Cv1 when the output pattern of ZVS detection circuit Z1 is the first pattern. In FIG. 5A, Vtune indicates an applied voltage to the control terminal of variable capacitance Cv1, and Cvar indicates the capacitance value of variable capacitance Cv1.

As illustrated in FIG. 5A, microcomputer 11 decreases the capacitance value of variable capacitance Cv1 by, for example, increasing an applied voltage to the control terminal of variable capacitance Cv1.

When the output pattern of ZVS detection circuit Z1 is the second pattern (the second pattern in step S11), i.e., when the voltage across switch Q1 increases again to be higher than the predetermined threshold voltage after changing from the state of being higher than the predetermined threshold voltage to the state of being the predetermined threshold voltage or lower, microcomputer 11 controls the capacitance value of variable capacitance Cv1 to increase the capacitance value of variable capacitance Cv1 (step S13). When an example of realizing variable capacitance Cv1 is the one illustrated in FIG. 2A, for example, microcomputer 11 controls the capacitance value of variable capacitance Cv1, as illustrated in FIG. 5B.

FIG. 5B is a diagram illustrating a control example of variable capacitance Cv1 when the output pattern of ZVS detection circuit Z1 is the second pattern. In FIG. 5B, Vtune indicates an applied voltage to the control terminal of variable capacitance Cv1, and Cvar indicates the capacitance value of variable capacitance Cv1.

As illustrated in FIG. 5B, microcomputer 11 increases the capacitance value of variable capacitance Cv1 by, for example, decreasing an applied voltage to the control terminal of variable capacitance Cv1.

When the output pattern of ZVS detection circuit Z1 is the OK pattern (the OK pattern in step S11), i.e., when the voltage across switch Q1 changes from the state of being higher than the predetermined threshold voltage to the state of being the predetermined threshold voltage or lower, microcomputer 11 controls the capacitance value of variable capacitance Cv1 to keep the capacitance value of variable capacitance Cv1 (i.e., ends the process of changing the capacitance value of variable capacitance Cv1).

By controlling the capacitance value of variable capacitance Cv1, it is possible to control, by the excitation current of transformer T1, the speed of drawing electric charges accumulated in the output capacity of switch Q1, thereby turning on switch Q1 when the voltage across switch Q1 is the predetermined threshold voltage or lower (i.e., ZVS can be achieved).

For example, switch Q1 and switch Q2 have an approximately same parameter, and each of the parasitic capacities (capacitors C1 and C2) has an approximately same capacitance value. For this reason, when switch Q1 is in a hard switching state, switch Q2 is also in a hard switching state. Accordingly, microcomputer 11 controls the capacitance value of variable capacitance Cv2 in the same manner as the capacitance value of variable capacitance Cv1. In other words, when controlling the capacitance value of variable capacitance Cv1 to decrease the capacitance value of variable capacitance Cv1, microcomputer 11 controls also the capacitance value of variable capacitance Cv2 to decrease the capacitance value of variable capacitance Cv2, and when controlling the capacitance value of variable capacitance Cv1 to increase the capacitance value of variable capacitance Cv1, microcomputer 11 controls the capacitance value of variable capacitance Cv2 to increase the capacitance value of variable capacitance Cv2. When controlling the capacitance value of variable capacitance Cv1 to keep the capacitance value of variable capacitance Cv1, microcomputer 11 controls the capacitance value of variable capacitance Cv2 to keep also the capacitance value of variable capacitance Cv2. With this, when determining that switch Q1 is not performing ZVS, based on a detection result obtained by ZVS detection circuit Z1, microcomputer 11 determines that switch Q2 also is not performing ZVS and controls variable capacitances Cv1 and Cv2 in the same manner. This can cause switches Q1 and Q2, which have been in a hard switching state, to perform soft switching (ZVS).

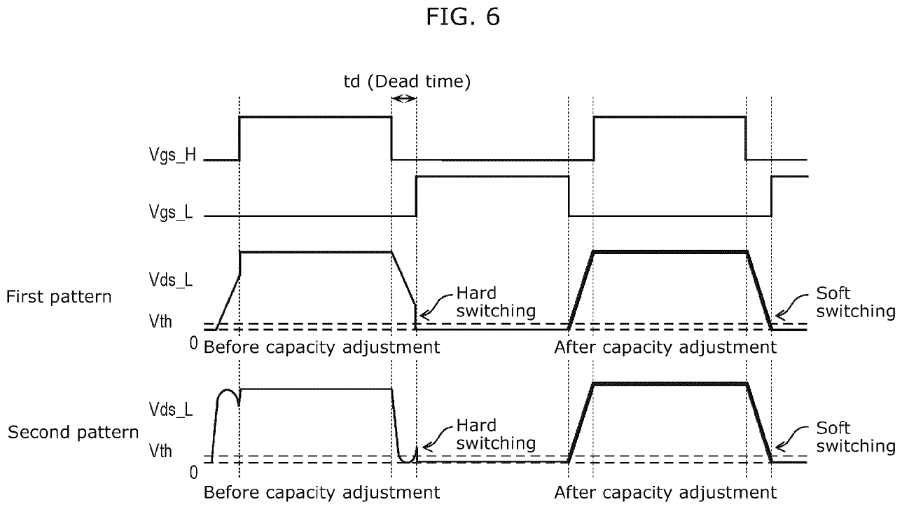

FIG. 6 is a diagram illustrating that soft switching is achieved by controlling variable capacitances Cv1 and Cv2. FIG. 6 illustrates, from top, the gate-source voltage of switch Q1 (Vgs_H), the gate-source voltage of switch Q2 (Vgs_L), a voltage across switch Q2 in the case of the first pattern (Vds_L), and a voltage across switch Q2 in the case of the second pattern (Vds_L). In FIG. 6, the left side in the graph shows a state before capacity adjustment, and the right side in the graph shows a state after capacity adjustment.

When the output pattern of ZVS detection circuit Z1 is the first pattern, i.e., when the voltage across switch Q1 is constantly higher than the predetermined threshold voltage in the dead time, the output capacities of switches Q1 and Q2 are large and the speed of drawing electric charges accumulated in the output capacities decreases. For this reason, electric charges remain in the output capacities when switches Q1 and Q2 are turned on and switches Q1 and Q2 are in a hard switching state, as in the state before capacity adjustment illustrated in FIG. 6. Accordingly, in this case, by decreasing the capacitance values of variable capacitances Cv1 and Cv2, it is possible to increase the speed of drawing electric charges accumulated in the output capacities of switches Q1 and Q2, thereby bringing the voltage across switch Q1 and the voltage across Q2 at the timing when the dead time ends to be the predetermined threshold voltage or lower at the timing when the dead time ends. This enables turning on switches Q1 and Q2 when the voltage across switch Q1 and the voltage across switch Q2 are each the predetermined threshold voltage or lower, thereby causing switches Q1 and Q2 to perform soft switching, as in the state after capacity adjustment illustrated in FIG. 6.

When the output pattern of ZVS detection circuit Z1 is the second pattern, i.e., when the voltage across switch Q1 increases again to be higher than the predetermined threshold voltage after changing from the state of being higher than the predetermined threshold voltage to the state of being the predetermined threshold voltage or lower, the output capacities of switches Q1 and Q2 are small and the speed of drawing electric charges accumulated in the output capacities increases. For this reason, electric charges are accumulated by an excitation current after the electric charges in the output capacities of switches Q1 and Q2 are drawn to be 0 until the dead time ends, and switches Q1 and Q2 are in a hard switching state when switches Q1 and Q2 are turned on, as in the state before capacity adjustment illustrated in FIG. 6. Accordingly, in this case, by increasing the capacitance values of variable capacitances Cv1 and Cv2, it is possible to decrease the speed of drawing the electric charges accumulated in the output capacities of switches Q1 and Q2, thereby bringing the voltage across switch Q1 and the voltage across switch Q2 to the predetermined threshold value or lower at the timing when the dead time ends. This enables turning on switches Q1 and Q2 when the voltage across switch Q1 and the voltage across switch Q2 are each the predetermined threshold voltage or lower, thereby causing switches Q1 and Q2 to perform soft switching, as in the state after capacity adjustment illustrated in FIG. 6.

Switches Q1 and Q2 are in a hard switching state when, for example, a load fluctuates, an input voltage fluctuates, and a switching frequency fluctuates.

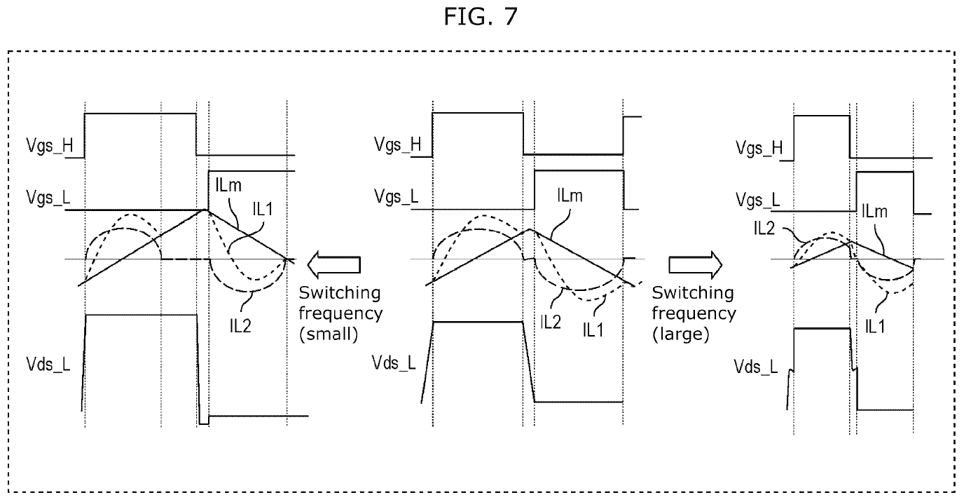

When a switching frequency fluctuates, for example, an excitation current fluctuates, the speed of drawing electric charges accumulated in switch Q1 and switch Q2 changes, and switch Q1 and switch Q2 are in a hard switching state. This will be described with reference to FIG. 7.

FIG. 7 is a diagram for illustrating the relationship between a switching frequency and an excitation current. FIG. 7 illustrates, from top, the gate-source voltage of switch Q1 (Vgs_H), the gate-source voltage of switch Q2 (Vgs_L), a current related to transformer T1 (specifically, an input current (IL1) to transformer T1, an output current (IL2) from transformer T1, an excitation current (ILm)), and a voltage across switch Q2 (Vds_L). In FIG. 7, the left side in the graph shows a case where a switching frequency is lower than a switching frequency at the center, and the right side in the graph shows a case where the switching frequency is higher than the switching frequency at the center.

At the center in FIG. 7, a chart in the case where switches Q1 and Q2 are performing soft switching. When a switching frequency decreases from the state at the center in FIG. 7, for example, an excitation current increases as shown on the left in FIG. 7. It should be noted that an excitation current is obtained by subtracting an output current from transformer T1 from an input current to transformer T1 (i.e., ILm=IL1−IL2). When the excitation current increases, the speed of drawing electric charges accumulated in the output capacities of switches Q1 and Q2 increases and the output pattern of ZVS detection circuit Z1 is the second pattern. In other words, switches Q1 and Q2 are in a hard switching state. When the switching frequency increases from the state at the center in FIG. 7, for example, the excitation current decreases as illustrated on the right side in FIG. 7. When the excitation current decreases, the speed of drawing the electric charges accumulated in the output capacities of switches Q1 and Q2 decreases and the output pattern of ZVS detection circuit Z1 is the first pattern. In other words, switches Q1 and Q2 are in a hard switching state.

Power conversion device 1 includes ZVS detection circuit Z1, and the capacitance values of variable capacitances Cv1 and Cv2 are adjusted to values in accordance with a detection result obtained by ZVS detection circuit Z1 so that switches Q1 and Q2 are controlled to perform soft switching. Accordingly, even when the switching frequency fluctuates, power conversion device 1 can achieve soft switching.

It should be noted that microcomputer 11 may control the capacitance values of variable capacitances Cv1 and Cv2 based on a detection result obtained by ZVS detection circuit Z1 and a detection result obtained by excitation current detection circuit 13. Since an excitation current is an element that can draw electric charges accumulated in the output capacities of switches Q1 and Q2 to which variable capacitances Cv1 and Cv2 are respectively connected and that greatly affects the achievement of soft switching, soft switching can be achieved more accurately by using also a detection result obtained by the excitation current itself.

Since an excitation current decreases and the output capacities of switches Q1 and Q2 increase when an input voltage fluctuates, specifically, when an input voltage decreases, the speed of drawing electric charges accumulated in switches Q1 and Q2 decreases and switches Q1 and Q2 are in a hard switching state. It should be noted that since the output capacities of switches Q1 and Q2 increase as an applied voltage decreases, the output capacities of switches Q1 and Q2 increase when the input voltage decreases.

Since power conversion device 1 includes ZVS detection circuit Z1 and switches Q1 and Q2 are controlled to perform soft switching, power conversion device 1 can achieve soft switching even when an input voltage fluctuates.

It should be noted that microcomputer 11 may control the capacitance values of variable capacitances Cv1 and Cv2 based on a detection result obtained by ZVS detection circuit Z1 and a detection result obtained by input voltage detection circuit 14. Since the input voltage of power conversion device 1 has a correlation with the output capacities of switches Q1 and Q2 as well as an excitation current that greatly affects the achievement of soft switching, soft switching can be achieved more accurately by using also a detection result obtained by the input voltage itself.

When a load fluctuates, for example, it is necessary to cause a switching frequency to fluctuate since an output voltage fluctuates from a target voltage. When the output voltage decreases to be lower than the target voltage, for example, it is necessary to increase the output voltage to be close to the target voltage by decreasing the switching frequency. When the output voltage increases to be higher than the target voltage, for example, it is necessary to decrease the output voltage to be close to the target voltage by increasing the switching frequency. In other words, in this case, the switching frequency fluctuates, the excitation current fluctuates as the switching frequency fluctuates, the speed of drawing electric charges accumulated in switches Q1 and Q2 changes, and switches Q1 and Q2 are in a hard switching state.

Since power conversion device 1 includes ZVS detection circuit Z1, and switches Q1 and Q2 are controlled to perform soft switching, power conversion device 1 can achieve soft switching even when a load fluctuates (i.e., when an output voltage fluctuates).

Although an example in which microcomputer 11 determines whether the output pattern of ZVS detection circuit Z1 is a first pattern, a second pattern, or an OK pattern to control the capacitance values of variable capacitances Cv1 and Cv2 to increase or decrease the capacitance values of variable capacitances Cv1 and Cv2 is described with reference to FIG. 3, the present disclosure is not limited to this example. For example, if microcomputer 11 knows whether switches Q1 and Q2 are in a hard switching state as a result of an increase or a decrease in the switching frequency, microcomputer 11 can control the capacitance values of variable capacitances Cv1 and Cv2 even without performing the pattern determination described above.

For example, the fact that switches Q1 and Q2 are in a hard switching state as a result of a decrease in the switching frequency means that an excitation current increases and the speed of drawing electric charges accumulated in the output capacities of switches Q1 and Q2 increases. In other words, when switches Q1 and Q2 are in a hard switching state as a result of a decrease in the switching frequency, it is possible to know, even without monitoring the fluctuation of a voltage across switch Q1 and a voltage across switch Q2 through dead time, that the voltages during the dead time fluctuate like in the second pattern. Therefore, when switches Q1 and Q2 are in a hard switching state as a result of a decrease in the switching frequency, microcomputer 11 can control the capacitance values of variable capacitances Cv1 and Cv2 to increase the capacitance values of variable capacitances Cv1 and Cv2 even without performing the pattern determination described above.

For example, the fact that switches Q1 and Q2 are in a hard switching state as a result of an increase in the switching frequency means that an excitation current decreases and the speed of drawing electric charges accumulated in the output capacities of switches Q1 and Q2 decreases. In other words, when switches Q1 and Q2 are in a hard switching state as a result of an increase in the switching frequency, it is possible to know, even without monitoring the fluctuation of the voltage across switch Q1 and the voltage across switch Q2 through dead time, that the voltages during the dead time fluctuate like in the first pattern. Therefore, when switches Q1 and Q2 are in a hard switching state as a result of an increase in the switching frequency, microcomputer 11 can control the capacitance values of variable capacitances Cv1 and Cv2 to decrease the capacitance values of variable capacitances Cv1 and Cv2 even without performing the pattern determination described above.

As described above, the capacitance values of variable capacitances Cv1 and Cv2 are controlled in accordance with the result of detecting whether switch Q1 to which variable capacitance Cv1 is connected is performing ZVS. In other words, when it is detected that switch Q1 no longer performs ZVS in the case where, for instance, a load fluctuates, an input voltage fluctuates, or a switching frequency fluctuates, it is possible to control the capacitance values of variable capacitances Cv1 and Cv2 so that ZVS of switches Q1 and Q2 is performed. Accordingly, it is possible to provide improved power conversion device 1 capable of achieving soft switching.

### Variation of Embodiment 1

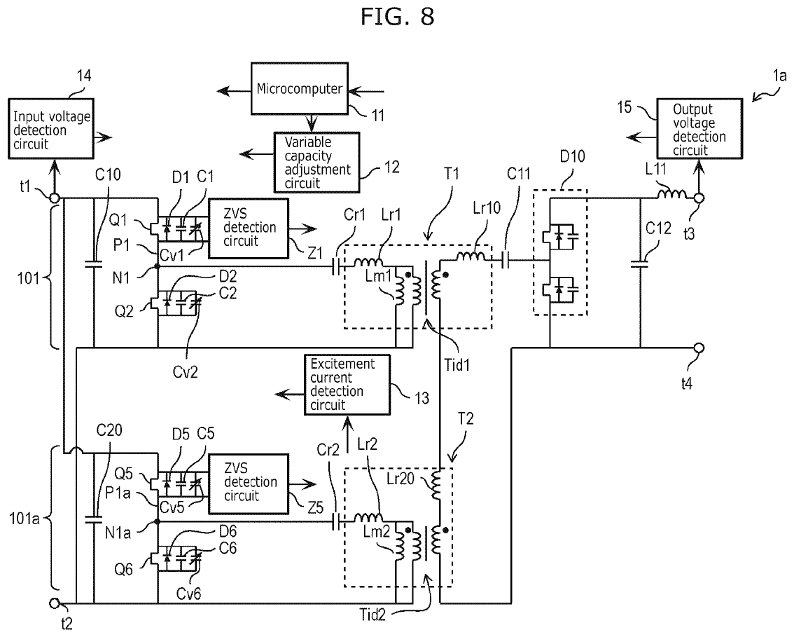

Next, a power conversion device according to a variation of Embodiment 1 will be described with reference to FIG. 8.

FIG. 8 is a configuration diagram illustrating one example of power conversion device 1a according to the variation of Embodiment 1.

In the variation of Embodiment 1, power conversion device 1a includes circuits each of which includes switches Q1 and Q2 as well as transformer T1 described in Embodiment 1, and the circuits are connected to each other in parallel. This enables power conversion device 1a to perform higher output. FIG. 8 shows an example in which power conversion device 1a has two circuits each of which includes switches Q1 and Q2 as well as transformer T1 described in Embodiment 1, and switches Q5 and Q6 as well as transformer T2 are shown as elements corresponding to switches Q1 and Q2 as well as transformer T1. Since power conversion device 1a according to the variation of Embodiment 1 is basically the same as power conversion device 1 according to Embodiment 1 except that power conversion device 1a includes the circuits, the following omits points similar to power conversion device 1 according to Embodiment 1 and focuses on differences.

Power conversion device 1a is a DCDC converter that increases or decreases an input voltage to a predetermined voltage and outputs the increased or decreased voltage. Power conversion device 1a is, for example, an LLC converter. Power conversion device 1a includes, in addition to the elements included in power conversion device 1, switches Q5 and Q6, variable capacitances Cv5 and Cv6, capacitors Cr2 and C20, transformer T2, and ZVS detection circuit Z5.

Switch Q5 is one example of a first switch provided on path Pla connecting terminal t1 and terminal t2. Switch Q6 is one example of a second switch provided on path Pla and connected to switch Q5 in series.

Switch Q5 is, for example, an N-channel MOSFET. In FIG. 8, the parasitic capacity of switch Q5 is shown as capacitor C5, and capacitor C5 is connected to switch Q5 in parallel in an equivalent circuit. The drain of switch Q5 is connected to terminal t1 and the source of switch Q5 is connected to the drain of switch Q6. In FIG. 8, the parasitic capacity of switch Q5 is shown as diode D5, and the anode of diode D5 is connected to the source of switch Q5 while the cathode of diode D5 is connected to the drain of switch Q5 in the equivalent circuit.

Switch Q6 is, for example, an N-channel MOSFET. In FIG. 8, the parasitic capacity of switch Q6 is shown as capacitor C6, and capacitor C6 is connected to switch Q6 in parallel in an equivalent circuit. The drain of switch Q6 is connected to the source of switch Q5 and the source of switch Q6 is connected to terminal t2. In FIG. 8, the parasitic diode of switch Q6 is shown as diode D6, and the anode of diode D6 is connected to the source of switch Q6 while the cathode of switch Q6 is connected to the drain of switch Q6 in the equivalent circuit.

Transformer T2 includes a primary winding and a secondary winding, and the primary winding is connected to node Nia between switch Q5 and switch Q6 on path Pla. For example, the primary winding of transformer T2 is connected to node N1a via capacitor Cr2. In FIG. 8, the equivalent circuit of transformer T2 is shown, and transformer T2 can be presented by ideal transformer Tid2, excitation inductance Lm2, leakage inductance Lr2, as well as leakage inductance Lr20 on the secondary side. Excitation inductance Lm2 is connected to the primary-side coil of ideal transformer Tid2 in parallel, leakage inductance Lr2 is connected to the primary-side coil of ideal transformer Tid2 in series, and leakage inductance Lr20 is connected to the secondary-side coil of ideal transformer Tid2 in series. It should be noted that power conversion device 1a may include an inductor equivalent to leakage inductance Lr2, an inductor equivalent to excitation inductance Lm2, and an inductor equivalent to leakage inductance Lr20.

Variable capacitance Cv5 is connected to switch Q5 in parallel, and variable capacitance Cv6 is connected to switch Q6 in parallel. It should be noted that power conversion device 1a needs to include a variable capacitance connected in parallel to one of switches Q5 and Q6, and does not necessarily need to include both of variable capacitances Cv5 and Cv6.

The capacitance values of variable capacitances Cv5 and Cv6 are values in accordance with a detection result obtained by ZVS detection circuit Z5.

The output capacity of switch Q5 is the combined capacity of capacitor C5 and variable capacitance Cv5, and the output capacity of switch Q5 can be adjusted by controlling variable capacitance Cv5. The output capacity of switch Q6 is the combined capacity of capacitor C6 and variable capacitance Cv6, and the output capacity of switch Q6 can be adjusted by controlling variable capacitance Cv6.

ZVS detection circuit Z5 detects whether switches Q5 and Q6 are performing ZVS, based on a voltage across switch Q5 or Q6 (specifically, a drain-source voltage) to which a variable capacitance is connected. In the example in FIG. 8, ZVS detection circuit Z5 detects whether switches Q5 and Q6 are performing ZVS, based on the voltage across switch Q5 to which variable capacitance Cv5 is connected. For example, ZVS detection circuit Z5 is connected to switch Q5 in parallel and detects the voltage across switch Q5. ZVS detection circuit Z5 outputs the detection result to microcomputer 11.

Capacitor Cr2 is connected between node N1a and the primary winding of transformer T2. Capacitor Cr2 is a resonance capacitor in an LLC converter.

Capacitor C20 is an input capacitor connected between terminal t1 and terminal t2.

Rectifier circuit D10 is connected to the secondary winding of transformer T1 and the secondary winding of transformer T2. Since the primary side of each of the circuits in power conversion device 1a has a half-bridge configuration, rectifier circuit D10 on the secondary side also has a half-bridge configuration.

Microcomputer 11 is a circuit for controlling switching (on and off) of switches (e.g., switches Q1, Q2, Q5, and Q6) included in power conversion device 1a. For example, microcomputer 11 controls switching of switches Q1, Q2, Q5, and Q6 by controlling gate drive circuits (not shown in the figure) connected to the gates of switches Q1, Q2, Q5, and Q6. It should be noted that the switching frequencies of switches Q1, Q2, Q5, and Q6 in each of the circuits are same. In other words, microcomputer 11 controls switching of switches Q1, Q2, Q5, and Q6 so that the switching frequencies of switches Q1, Q2, Q5, and Q6 are same.

Microcomputer 11 also controls the capacitance values of variable capacitances Cv1, Cv2, Cv5, and Cv6 based on detection results of ZVS detection circuits Z1 and Z5. For example, microcomputer 11 controls the capacitance values of variable capacitances Cv1, Cv2, Cv5, and Cv6 via variable capacitance adjustment circuit 12. When increasing the capacitance values of variable capacitances Cv1, Cv2, Cv5, and Cv6, for example, microcomputer 11 instructs variable capacitance adjustment circuit 12 to increase the capacitance values of variable capacitances Cv1, Cv2, Cv5, and Cv6 by a fixed amount so that the capacitance values are greater than the present capacitance values. When decreasing the capacitance values of variable capacitances Cv1, Cv2, Cv5, and Cv6, for example, microcomputer 11 instructs variable capacitance adjustment circuit 12 to decrease the capacitance values of variable capacitances Cv1, Cv2, Cv5, and Cv6 by a fixed amount so that the capacitance values are less than the present capacitance values.

Thus, switches Q1 and Q2, transformer T1, variable capacitances Cv1 and Cv2, and ZVS detection circuit Z1 configure primary-side circuit 101, while switches Q5 and Q6, transformer T2, variable capacitances Cv5 and Cv6, and ZVS detection circuit Z5 configure primary-side circuit 101a. Power conversion device 1a includes primary-side circuits 101 and 101a. Primary-side circuits 101 and 101a are connected to each other in parallel.

It should be noted that power conversion device 1a may include variable capacitance adjustment circuit 12 for each variable capacitance. In other words, power conversion device 1 may include variable capacitance adjustment circuit 12 for adjusting variable capacitance Cv1, variable capacitance adjustment circuit 12 for adjusting variable capacitance Cv2, variable capacitance adjustment circuit 12 for adjusting variable capacitance Cv5, and variable capacitance adjustment circuit 12 for adjusting variable capacitance Cv6.

Excitation current detection circuit 13 detects an excitation current that flows through excitation inductances Lm1 and Lm2. Since the input side of transformer T1 or T2 forms a parallel circuit and the output side of transformer T1 or T2 forms a series circuit, the excitation current of each phase is calculated using the half of an output current (it should be noted that strictly speaking, the ratio between the number of windings of transformer T1 and the number of windings of transformer T2 is also taken into consideration when the excitation current is calculated). Specifically, an excitation current flowing through excitation inductance Lm1 can be obtained by subtracting the half of an output current from transformers T1 and T2 from an input current to transformer T1 that flows along the path connecting node N1 and the primary winding of transformer T1 (the path in which capacitor Cr1 is provided). Likewise, an excitation current flowing through excitation inductance Lm2 can be obtained by subtracting the half of an output current from transformers T1 and T2 from an input current to transformer T2 that flows along the path connecting node N1a and the primary winding of transformer T2 (the path in which capacitor Cr2 is provided). For this reason, excitation current detection circuit 13 may detect an excitation current by, for example, detecting an input current to transformers T1 and T2 as well as an output current from transformers T1 and T2.

Microcomputer 11 determines whether to decrease, increase, or keep the capacitance values of variable capacitances Cv5 and Cv6, based on a detection result obtained by ZVS detection circuit Z5. For example, microcomputer 11 controls the capacitance value of variable capacitance Cv5 to turn on switch Q5 when a voltage across switch Q5 to which variable capacitance Cv5 is connected is a predetermined threshold voltage or lower, and controls the capacitance value of variable capacitance Cv6 to turn on switch Q6 when a voltage across switch Q6 to which variable capacitance Cv6 is connected is a predetermined threshold voltage or lower.

For example, ZVS detection circuit Z5 has functions of a comparator that compares a voltage across switch Q5 and a predetermined threshold voltage, outputs 1 to microcomputer 11 when the voltage across switch Q5 is higher than the predetermined threshold voltage, and outputs 0 to microcomputer 11 when the voltage across switch Q5 is the predetermined threshold voltage or lower.

Microcomputer 11 determines the output pattern of ZVS detection circuit Z5 in dead time during which switches Q5 and Q6 are both turned off when switches Q5 and Q6 repeat being turned on and off alternately. Specifically, microcomputer 11 determines whether the output pattern of ZVS detection circuit Z5 in the dead time is a first pattern, a second pattern, or an OK pattern.

When the output pattern of ZVS detection circuit Z5 is the first pattern, i.e., when the voltage across switch Q5 is constantly higher than the predetermined threshold voltage, microcomputer 11 controls the capacitance values of variable capacitances Cv5 and Cv6 to decrease the capacitance values of variable capacitances Cv5 and Cv6.

When the output pattern of ZVS detection circuit Z5 is the second pattern, i.e., when the voltage across switch Q5 increases again to be higher than the predetermined threshold voltage after changing from the state of being higher than the predetermined threshold voltage to the state of being the predetermined threshold voltage or lower, microcomputer 11 controls the capacitance values of variable capacitances Cv5 and Cv6 to increase the capacitance values of variable capacitances Cv5 and Cv6.

When the output pattern of ZVS detection circuit Z5 is the OK pattern, i.e., when the voltage across switch Q5 is changed from the state of being higher than the predetermined threshold voltage to the state of being the predetermined threshold voltage or lower, microcomputer 11 controls the capacitance values of variable capacitances Cv5 and Cv6 to keep the capacitance values of variable capacitances Cv5 and Cv6.

By controlling the capacitance values of variable capacitances Cv5 and Cv6, it is possible to control, by the excitation current of transformer T2, the speed of drawing electric charges accumulated in the output capacities of switches Q5 and Q6, thereby turning on switches Q5 and Q6 when the voltage across switch Q5 and the voltage across switch Q6 are each the predetermined threshold voltage or lower.

When it is detected that ZVS of switches Q1 and Q5 is no longer performed in the case where a load fluctuates, an input voltage fluctuates, or a switching frequency fluctuates, power conversion device 1a, like power conversion device 1, can control the capacitance values of variable capacitances Cv1, Cv2, Cv5, and Cv6 so that ZVS of switches Q1, Q2, Q5, and Q6 is performed.

It should be noted that in power conversion device 1a, circuits are connected in parallel, and the output capacities of switches or the excitation inductances of transformers may vary among the circuits. In this case, when the capacitance values of variable capacitances Cv1, Cv2, Cv5, and Cv6 are controlled in the same manner, one of a combination of switches Q1 and Q2 or a combination of switches Q5 and Q6 may remain to be in a hard switching state. This is because the output capacities of the switches or the excitation inductances of the transformers are varied among the circuits, and therefore, the speed of drawing electric charges accumulated in the output capacities also varies depending on the excitation current.

However, even when the output capacities of the switches or the excitation inductances of the transformers are varied among the circuits, power conversion device 1a can achieve soft switching. This is because power conversion device 1a includes a ZVS detection circuit in each of the circuits. Specifically, the capacitance values of variable capacitances Cv1 and Cv2 are adjusted to values in accordance with the detection result obtained by ZVS detection circuit Z1 so that switches Q1 and Q2 are controlled to perform soft switching, and the capacitance values of variable capacitances Cv5 and Cv6 are adjusted to values in accordance with a detection result obtained by ZVS detection circuit Z5 so that switches Q5 and Q6 are controlled to perform soft switching.

Thus, even when the output capacities of the switches or the excitation inductances of the transformers are varied among the circuits, power conversion device 1a can achieve soft switching since power conversion device 1a includes ZVS detection circuits Z1 and Z5 and each of the combination of switches Q1 and Q2 and the combination of switches Q5 and Q6 is controlled so that soft switching can be performed.

### Embodiment 2

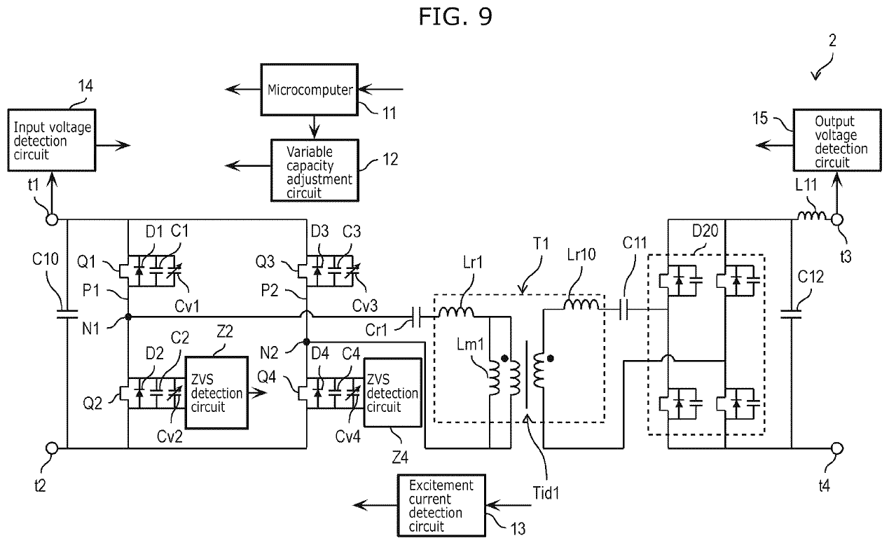

Next, a power conversion device according to Embodiment 2 will be described with reference to FIG. 9.

FIG. 9 is a configuration diagram illustrating one example of power conversion device 2 according to Embodiment 2.

Embodiment 1 has described an example in which the primary side of the power conversion device has a half-bridge configuration, but Embodiment 2 describes an example in which the primary side of power conversion device 2 has a full-bridge configuration. Owing to the primary side of power conversion device 2 having a full-bridge configuration, power conversion device 2 can perform higher output.

Since power conversion device 2 according to Embodiment 2 is basically the same as power conversion device 1 according to Embodiment 1 except that the primary side has a full-bridge configuration, the following omits points similar to power conversion device 1 according to Embodiment 1 and focuses on differences.

Power conversion device 2 is an interleaved power conversion device, and is a DCDC converter that increases or decreases an input voltage to a predetermined voltage and outputs the increased or decreased voltage. Power conversion device 2 is, for example, an LLC converter. Power conversion device 2 includes ZVS detection circuit Z2 instead of ZVS detection circuit Z1, rectifier circuit D20 instead of rectifier circuit D10, and further includes switches Q3 and Q4, variable capacitances Cv3 and Cv4, and ZVS detection circuit Z4, and the other elements are the same as the elements included in power conversion device 1.

Switch Q3 is one example of a third switch that is provided on path P2 different from path P1 and connects terminal t1 and terminal t2. Path P2 is one example of a second path. Switch Q4 is one example of a fourth switch provided on path P2 and connected to switch Q3 in series.

Switch Q3 is, for example, an N-channel MOSFET. In FIG. 9, the parasitic capacity of switch Q3 is shown as capacitor C3, and capacitor C3 is connected to switch Q3 in parallel in an equivalent circuit. The drain of switch Q3 is connected to terminal t1 and the source of switch Q3 is connected to the drain of switch Q4. In FIG. 9, the parasitic diode of switch Q3 is shown as diode D3, and the anode of diode D3 is connected to the source of switch Q3 while the cathode of diode D3 is connected to the drain of switch Q3 in the equivalent circuit.

Switch Q4 is, for example, an N-channel MOSFET. In FIG. 9, the parasitic capacity of switch Q4 is shown as capacitor C4, and capacitor C4 is connected to switch Q4 in parallel in an equivalent circuit. The drain of switch Q4 is connected to the source of switch Q3, and the source of switch Q4 is connected to terminal t2. In FIG. 9, the parasitic diode of switch Q4 is shown as diode D4, and the anode of diode D4 is connected to the source of switch Q4 while the cathode of diode D4 is connected to the drain of switch Q4 in the equivalent circuit.

The primary winding of transformer T1 is connected between node N1 and node N2 between switch Q3 and switch Q4 on path P2. Node N2 is one example of a second node. For example, the secondary winding of transformer T1 is connected to rectifier circuit D20 via capacitor C11.

Variable capacitance Cv3 is connected to switch Q3 in parallel, and variable capacitance Cv4 is connected to switch Q4 in parallel. It should be noted that power conversion device 2 needs to include a variable capacitance connected in parallel to one of switches Q3 and Q4, and does not necessarily need to include both of variable capacitances Cv3 and Cv4.

The capacitance values of variable capacitances Cv1 and Cv2 are values in accordance with the detection result obtained by ZVS detection circuit Z2, and the capacitance values of variable capacitances Cv3 and Cv4 are values in accordance with the detection result obtained by ZVS detection circuit Z4.

The output capacity of switch Q3 is the combined capacity of capacitor C3 and variable capacitance Cv3, and the output capacity of switch Q3 can be adjusted by controlling variable capacitance Cv3. The output capacity of switch Q4 is the combined capacity of capacitor C4 and variable capacitance Cv4, and the output capacity of switch Q4 can be adjusted by controlling variable capacitance Cv4.

ZVS detection circuit Z2 detects whether switches Q1 and Q2 are performing ZVS, based on a voltage across switch Q1 or Q2 (specifically, a drain-source voltage) to which a variable capacitance is connected. In the example in FIG. 9, ZVS detection circuit Z2 detects whether switches Q1 and Q2 are performing ZVS, based on the voltage across switch Q2 to which variable capacitance Cv2 is connected. For example, ZVS detection circuit Z2 is connected to switch Q2 in parallel and detects the voltage across switch Q2. ZVS detection circuit Z2 outputs the detection result to microcomputer 11.

ZVS detection circuit Z4 detects whether switches Q3 and Q4 are performing ZVS, based on a voltage across switch Q3 or switch Q4 (specifically, a drain-source voltage) to which a variable capacitance is connected. In the example in FIG. 9, ZVS detection circuit Z4 detects whether switches Q3 and Q4 are performing ZVS, based on the voltage across switch Q4 to which variable capacitance Cv4 is connected. For example, ZVS detection circuit Z4 is connected to switch Q4 in parallel and detects the voltage across switch Q4. ZVS detection circuit Z4 outputs the detection result to microcomputer 11.

Embodiment 1 describes an example in which a ZVS detection circuit is provided in a High-side switch (e.g., switch Q1 or Q3), but the ZVS detection circuit may be provided in a Low-side switch (e.g., switch Q2 or Q4), as in Embodiment 2.

Rectifier circuit D20 is connected to the secondary winding of transformer T1. Since the primary side of rectifier circuit D20 has a full-bridge configuration, the secondary side of rectifier circuit D20 also has a full-bridge configuration. Capacitor C11 is provided between the secondary winding of transformer T1 and rectifier circuit D20.

Microcomputer 11 is a circuit for controlling switching (on and off) of switches (e.g., switches Q1, Q2, Q3, and Q4) included in power conversion device 2. For example, microcomputer 11 controls switching of switches Q1, Q2, Q3, and Q4 by controlling gate drive circuits (not shown in the figure) connected to the gates of switches Q1, Q2, Q3, and Q4. It should be noted that the operation of switches Q3 and Q4 can be readily implemented by using, for the gate signal of switches Q3 and Q4, a gate signal obtained by shifting the gate signal of switches Q1 and Q2 by a half cycle.

Microcomputer 11 also controls the capacitance values of variable capacitances Cv1, Cv2, Cv3, and Cv4 based on detection results of ZVS detection circuits Z2 and Z4. For example, microcomputer 11 controls the capacitance values of variable capacitances Cv1, Cv2, Cv3, and Cv4 via variable capacitance adjustment circuit 12. When increasing the capacitance values of variable capacitances Cv1, Cv2, Cv3, and Cv4, for example, microcomputer 11 instructs variable capacitance adjustment circuit 12 to increase, by a fixed amount, the capacitance values of variable capacitances Cv1, Cv2, Cv3, and Cv4 so that the capacitance values are greater than the present capacitance values. When decreasing the capacitance values of variable capacitances Cv1, Cv2, Cv3, and Cv4, for example, microcomputer 11 instructs variable capacitance adjustment circuit 12 to decrease, by a fixed amount, the capacitance values of variable capacitances Cv1, Cv2, Cv3, and Cv4 so that the capacitance values are less than the present capacitance values.

It should be noted that power conversion device 2 may include variable capacitance adjustment circuit 12 for each variable capacitance. In other words, power conversion device 2 may include variable capacitance adjustment circuit 12 for adjusting variable capacitance Cv1, variable capacitance adjustment circuit 12 for adjusting variable capacitance Cv2, variable capacitance adjustment circuit 12 for adjusting variable capacitance Cv3, and variable capacitance adjustment circuit 12 for adjusting variable capacitance Cv4.

Microcomputer 11 determines whether to decrease, increase, or keep the capacitance values of variable capacitances Cv1 and Cv2, based on a detection result obtained by ZVS detection circuit Z2, and determines whether to decrease, increase, or keep the capacitance values of variable capacitances Cv3 and Cv4, based on a detection result obtained by ZVS detection circuit Z4. For example, microcomputer 11 controls the capacitance value of variable capacitance Cv2 to turn on switch Q2 when a voltage across switch Q2 to which variable capacitance Cv2 is connected is a predetermined threshold voltage or lower, and controls the capacitance value of variable capacitance Cv1 to turn on switch Q1 when a voltage across switch Q1 to which variable capacitance Cv1 is connected is a predetermined threshold voltage or lower. Microcomputer 11 also controls the capacitance value of variable capacitance Cv4 to turn on switch Q4 when a voltage across switch Q4 to which variable capacitance Cv4 is connected is a predetermined threshold voltage or lower, and controls the capacitance value of variable capacitance Cv3 to turn on switch Q3 when a voltage across switch Q3 to which variable capacitance Cv3 is connected is a predetermined threshold voltage or lower.

For example, ZVS detection circuit Z2 has functions of a comparator that compares a voltage across switch Q2 and a predetermined threshold voltage, outputs 1 to microcomputer 11 when the voltage across switch Q2 is higher than the predetermined threshold voltage, and outputs 0 to microcomputer 11 when the voltage across switch Q2 is the predetermined threshold voltage or lower. For example, ZVS detection circuit Z4 has functions of a comparator that compares a voltage across switch Q4 and a predetermined threshold voltage, outputs 1 to microcomputer 11 when the voltage across switch Q4 is higher than the predetermined threshold voltage, and outputs 0 to microcomputer 11 when the voltage across switch Q4 is the predetermined threshold voltage or lower.

Microcomputer 11 determines the output pattern of ZVS detection circuit Z2 in dead time during which switches Q1 and Q2 are both turned off when switches Q1 and Q2 repeat being turned on and off alternately, and determines the output pattern of ZVS detection circuit Z4 in dead time during which switches Q3 and Q4 are both turned off when switches Q3 and Q4 repeat being turned on and off alternately. Specifically, microcomputer 11 determines whether the output patterns of ZVS detection circuit Z2 and Z4 in the dead time are each a first pattern, a second pattern, or an OK pattern.

When the output pattern of ZVS detection circuit Z2 is the first pattern, i.e., when the voltage across switch Q2 is constantly higher than the predetermined threshold voltage, microcomputer 11 controls the capacitance values of variable capacitances Cv1 and Cv2 to decrease the capacitance values of variable capacitances Cv1 and Cv2. When the output pattern of ZVS detection circuit Z4 is the first pattern, i.e., when the voltage across switch Q4 is constantly higher than the predetermined threshold voltage, microcomputer 11 controls the capacitance values of variable capacitances Cv3 and Cv4 to decrease the capacitance values of variable capacitances Cv3 and Cv4.

When the output pattern of ZVS detection circuit Z2 is the second pattern, i.e., when the voltage across switch Q2 increases again to be higher than the predetermined threshold voltage after changing from the state of being higher than the predetermined threshold voltage to the state of being the predetermined threshold voltage or lower, microcomputer 11 controls the capacitance values of variable capacitances Cv1 and Cv2 to increase the capacitance values of variable capacitances Cv1 and Cv2. When the output pattern of ZVS detection circuit Z4 is the second pattern, i.e., when the voltage across switch Q4 increases again to be higher than the predetermined threshold voltage after changing from the state of being higher than the predetermined threshold voltage to the state of being the predetermined threshold voltage or lower, microcomputer 11 controls the capacitance values of variable capacitances Cv3 and Cv4 to increase the capacitance values of variable capacitances Cv3 and Cv4.

When the output pattern of ZVS detection circuit Z2 is the OK pattern, i.e., when the voltage across switch Q2 is changed from the state of being higher than the predetermined threshold voltage to the state of being the predetermined threshold voltage or lower, microcomputer 11 controls the capacitance values of variable capacitances Cv1 and Cv2 to keep the capacitance values of variable capacitances Cv1 and Cv2. When the output pattern of ZVS detection circuit Z4 is the OK pattern, i.e., when the voltage across switch Q4 is changed from the state of being higher than the predetermined threshold voltage to the state of being the predetermined threshold voltage or lower, microcomputer 11 controls the capacitance values of variable capacitances Cv3 and Cv4 to keep the capacitance values of variable capacitances Cv3 and Cv4.

By controlling the capacitance values of variable capacitances Cv1 and Cv2, it is possible to control, by the excitation current of transformer T1, the speed of drawing electric charges accumulated in the output capacities of switches Q1 and Q2, thereby turning on switches Q1 and Q2 when the voltage across switch Q1 and the voltage across switch Q2 are each the predetermined threshold voltage or lower. By controlling the capacitance values of variable capacitances Cv3 and Cv4, it is possible to control, by the excitation current of transformer T1, also the speed of drawing electric charges accumulated in the output capacities of switches Q3 and Q4, thereby turning on switches Q3 and Q4 when the voltage across switch Q3 and the voltage across switch Q4 are each the predetermined threshold voltage or lower.

When it is detected that ZVS of switches Q2 and Q4 is no longer performed in the case where a load fluctuates, an input voltage fluctuates, or a switching frequency fluctuates, power conversion device 2, like power conversion device 1, can control the capacitance values of variable capacitances Cv1, Cv2, Cv3, and Cv4 so that ZVS of switches Q1, Q2, Q3, and Q4 is performed.

For example, switch Q1, switch Q2, switch Q3, and switch Q4 have approximately a same parameter, and each of the parasitic capacities (capacitors C1, C2, C3, and C4) has an approximately same capacitance value. For this reason, a ZVS detection circuit may be provided only in any one of switches Q1, Q2, Q3, and Q4 in a full-bridge configuration. In this case, microcomputer 11 may control the capacitance values of variable capacitances Cv1, Cv2, Cv3, and Cv4 based on a detection result obtained by the ZVS detection circuit provided in any one of switches Q1, Q2, Q3, and Q4. This is because under the condition that the hard switching state of any of switches Q1, Q2, Q3, and Q4 can be detected, it is possible to estimate that the other three switches are likewise in a hard switching state, and the hard switching state of switches Q1, Q2, Q3, and Q4 can be reset by controlling the capacitance values of variable capacitances Cv1, Cv2, Cv3, and Cv4 in the same manner.

### Variation of Embodiment 2

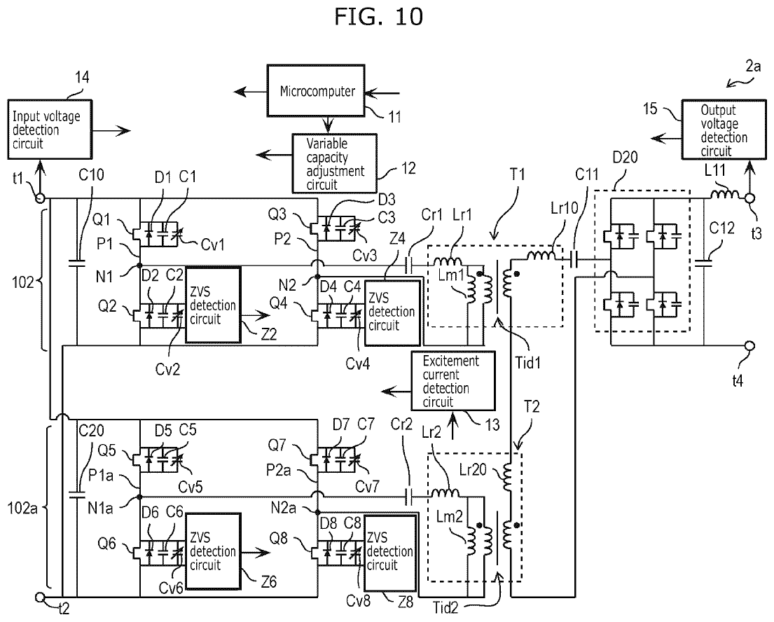

Next, a power conversion device according to a variation of Embodiment 2 will be described with reference to FIG. 10.

FIG. 10 is a configuration example illustrating one example of power conversion device 2a according to the variation of Embodiment 2.

In the variation of Embodiment 2, power conversion device 2a includes circuits each including switches Q1, Q2, Q3, and Q4 as well as transformer T1 that are described in Embodiment 2, and the circuits are connected to each other in parallel. This enables power conversion device 2a to perform higher output. FIG. 10 shows an example in which power conversion device 2a includes two circuits each including switches Q1, Q2, Q3, and Q4 as well as transformer T1 that are described in Embodiment 2, and switches Q5, Q6, Q7, and Q8 as well as transformer T2 are shown as elements corresponding to switches Q1, Q2, Q3, and Q4 as well as transformer T1. Since power conversion device 2a according to Embodiment 2 is basically the same as power conversion device 2 according to Embodiment 2 except for the point that power conversion device 2a includes the circuits described above, the following omits points similar to power conversion device 2 according to Embodiment and focuses on differences.

Power conversion device 2a is an interleaved power conversion device, and is a DCDC converter that increases or decreases an input voltage to a predetermined voltage and outputs the increased or decreased voltage. Power conversion device 2a is, for example, an LLC converter. Power conversion device 2a includes switches Q5, Q6, Q7, and Q8, variable capacitances Cv5, Cv6, Cv7, and Cv8, capacitors Cr2 and C20, transformer T2, and ZVS detection circuits Z5 and Z6, in addition to the elements included in power conversion device 2.

Switch Q5 is one example of a first switch provided on path Pla connecting terminal t1 and terminal t2. Switch Q6 is one example of a second switch provided on path Pla and connected to switch Q5 in series. Switch Q7 is one example of a third switch provided on path P2a different from path Pla connecting terminal t1 and terminal t2. Switch Q8 is one example a fourth switch provided on path P2a and connected to switch Q7 in series.

Switch Q5 is, for example, an N-channel MOSFET. In FIG. 10, the parasitic capacity of switch Q5 is shown as capacitor C5, and capacitor C5 is connected to switch Q5 in parallel in an equivalent circuit. The drain of switch Q5 is connected to terminal t1 and the source of switch Q5 is connected to the drain of switch Q6. In FIG. 10, the parasitic diode of switch Q5 is shown as diode D5, and the anode of diode D5 is connected to the source of switch Q5 while the cathode of diode D5 is connected to the drain of switch Q5 in the equivalent circuit.

Switch Q6 is, for example, an N-channel MOSFET. In FIG. 10, the parasitic capacity of switch Q6 is shown as capacitor C6, and capacitor C6 is connected to switch Q6 in parallel in an equivalent circuit. The drain of switch Q6 is connected to the source of switch Q5 and the source of switch Q6 is connected to terminal t2. In FIG. 10, the parasitic diode of switch Q6 is shown as diode D6, and the anode of diode D6 is connected to the source of switch Q6 while the cathode of switch Q6 is connected to the drain of switch Q6 in the equivalent circuit.

Switch Q7 is, for example, an N-channel MOSFET. In FIG. 10, the parasitic capacity of switch Q7 is shown as capacitor C7, and capacitor C7 is connected to switch Q7 in parallel in an equivalent circuit. The drain of switch Q7 is connected to terminal t1 and the source of switch Q7 is connected to the drain of switch Q8. In FIG. 10, the parasitic diode of switch Q7 is shown as diode D7, and the anode of diode D7 is connected to the source of switch Q7 while the cathode of diode D7 is connected to the drain of switch Q7 in the equivalent circuit.

Switch Q8 is, for example, an N-channel MOSFET. In FIG. 10, the parasitic capacity of switch Q8 is shown as capacitor C8 and capacitor C8 is connected to switch Q8 in parallel in an equivalent circuit. The drain of switch Q8 is connected to the source of switch Q7 and the source of switch Q8 is connected to terminal t2. In FIG. 10, the parasitic diode of switch Q8 is shown as diode D8, and the anode of diode D8 is connected to the source of switch Q8 while the cathode of diode D8 is connected to the drain of switch Q8 in the equivalent circuit.

Transformer T2 includes a primary winding and a secondary winding, and the primary winding is connected between node N1a between switches Q5 and Q6 on path Pla and node N2a between switch Q7 and switch Q8 on path P2a. For example, the primary winding of transformer T2 is connected to node N1a via capacitor Cr2. In FIG. 10, the equivalent circuit of transformer T2 is shown, and transformer T2 can be presented by ideal transformer Tid2, excitation inductance Lm2, and leakage inductance Lr2 as well as leakage inductance Lr20 on the secondary side. Excitation inductance Lm2 is connected to the primary-side coil of ideal transformer Tid2 in parallel and leakage inductance Lr20 is connected to the secondary-side coil of ideal transformer Tid2 in series. It should be noted that power conversion device 2a may include an inductor equivalent to leakage inductance Lr2, an inductor equivalent to excitation inductance Lm2, and an inductor equivalent to leakage inductance Lr20.

Variable capacitance Cv5 is connected to switch Q5 in parallel and variable capacitance Cv6 is connected to switch Q6 in parallel. It should be noted that power conversion device 1a needs to include a variable capacitance connected to one of switches Q5 and Q6, and does not necessarily need to include both of variable capacitances Cv5 and Cv6. Variable capacitance Cv7 is connected to switch Q7 in parallel, and variable capacitance Cv8 is connected to switch Q8 in parallel. It should be noted that power conversion device 2a needs to include a variable capacitance that is connected to one of switches Q7 and Q8, and does not necessarily need to include both of variable capacitances Cv7 and Cv8.

The capacitance values of variable capacitances Cv5 and Cv6 are values in accordance with a detection result obtained by ZVS detection circuit Z6, and the capacitance values of variable capacitances Cv7 and Cv8 are values in accordance with a detection result obtained by ZVS detection circuit Z8.

The output capacity of switch Q5 is the combined capacity of capacitor C5 and variable capacitance Cv5, and the output capacity of switch Q5 can be adjusted by controlling variable capacitance Cv5. The output capacity of switch Q6 is the combined capacity of capacitor C6 and variable capacitance Cv6, and the output capacity of switch Q6 can be adjusted by controlling variable capacitance Cv6. The output capacity of switch Q7 is the combined capacity of capacitor C7 and variable capacitance Cv7, and the output capacity of switch Q7 can be adjusted by controlling variable capacitance Cv7. The output capacity of switch Q8 is the combined capacity of capacitor C8 and variable capacitance Cv8, and the output capacity of switch Q8 can be adjusted by controlling variable capacitance Cv8.

ZVS detection circuit Z6 detects whether switches Q5 and Q6 are performing ZVS, based on a voltage across switch Q5 or Q6 (specifically, a drain-source voltage) to which a variable capacitance is connected. In the example in FIG. 10, ZVS detection circuit Z6 detects whether switches Q5 and Q6 are performing ZVS, based on the voltage across switch Q6 to which variable capacitance Cv6 is connected. For example, ZVS detection circuit Z6 is connected to switch Q6 in parallel and detects the voltage across switch Q6. ZVS detection circuit Z6 outputs the detection result to microcomputer 11.

ZVS detection circuit Z8 detects whether switches Q7 and Q8 are performing ZVS, based on a voltage across switch Q7 or Q8 (specifically, a drain-source voltage) to which a variable capacitance is connected. In the example in FIG. 10, ZVS detection circuit Z8 detects whether switches Q7 and Q8 are performing ZVS, based on the voltage across switch Q8 to which variable capacitance Cv8 is connected. For example, ZVS detection circuit Z8 is connected to switch Q8 in parallel and detects the voltage across switch Q8. ZVS detection circuit Z8 outputs the detection result to microcomputer 11.

Capacitor Cr2 is connected between node N1a and the primary winding of transformer T2. Capacitor Cr2 is a resonance capacitor in an LLC converter.

Capacitor C20 is an input capacitor connected between terminal t1 and terminal t2.

Rectifier circuit D20 is connected to the secondary winding of transformer T1 and the secondary winding of transformer T2. Since the primary side of each of the circuits in power conversion device 2a has a full-bridge configuration, rectifier circuit D20 on the secondary side also has a full-bridge configuration.

Microcomputer 11 is a circuit for controlling switching (on and off) of switches (e.g., switches Q1, Q2, Q3, Q4, Q5, Q6, Q7, and Q8) included in power conversion device 2a. For example, microcomputer 11 controls switching of switches Q1, Q2, Q3, Q4, Q5, Q6, Q7, and Q8 by controlling gate drive circuits (not shown in the figure) connected to the gates of switches Q1, Q2, Q3, Q4, Q5, Q6, Q7, and Q8. It should be noted that switches Q1, Q2, Q3, Q4, Q5, Q6, Q7, and Q8 in circuits have the same switching frequency. In other words, microcomputer 11 controls switching of switches Q1, Q2, Q3, Q4, Q5, Q6, Q7, and Q8 so that the switching frequencies of switches Q1, Q2, Q3, Q4, Q5, Q6, Q7, and Q8 are same.

Microcomputer 11 also controls the capacitance values of variable capacitances Cv1, Cv2, Cv3, Cv4, Cv5, Cv6, Cv7, and Cv8 based on detection results of ZVS detection circuits Z2, Z4, Z6, and Z8. For example, microcomputer 11 controls the capacitance values of variable capacitances Cv1, Cv2, Cv3, Cv4, Cv5, Cv6, Cv7, and Cv8 via variable capacitance adjustment circuit 12. When increasing the capacitance values of variable capacitances Cv1, Cv2, Cv3, Cv4, Cv5, Cv6, Cv7, and Cv8, for example, microcomputer 11 instructs variable capacitance adjustment circuit 12 to increase, by a fixed amount, the capacitance values of variable capacitances Cv1, Cv2, Cv3, Cv4, Cv5, Cv6, Cv7, and Cv8 so that the capacitance values are greater than the present capacitance values. When decreasing the capacitance values of variable capacitances Cv1, Cv2, Cv3, Cv4, Cv5, Cv6, Cv7, and Cv8, for example, microcomputer 11 instructs variable capacitance adjustment circuit 12 to decrease, by a fixed amount, the capacitance values of variable capacitances Cv1, Cv2, Cv3, Cv4, Cv5, Cv6, Cv7, and Cv8 so that the capacitance values are less than the present capacitance values.

Thus, switches Q1, Q2, Q3, and Q4, transformer T1, variable capacitances Cv1, Cv2, Cv3, and Cv4, and ZVS detection circuits Z2 and Z4 configure primary-side circuit 102, and switches Q5, Q6, Q7, and Q8, transformer T2, variable capacitances Cv5, Cv6, Cv7, and Cv8, and ZVS detection circuits Z6 and Z8 configure primary-side circuit 102a. Power conversion device 2a includes a plurality of primary-side circuits 102 and 102a. The plurality of primary-side circuits 102 and 102a are connected to each other in parallel.

It should be noted that power conversion device 2a may include variable capacitance adjustment circuit 12 for each variable capacitance. In other words, power conversion device 1 may include variable capacitance adjustment circuit 12 for adjusting variable capacitance Cv1, variable capacitance adjustment circuit 12 for adjusting variable capacitance Cv2, variable capacitance adjustment circuit 12 for adjusting variable capacitance Cv3, variable capacitance adjustment circuit 12 for adjusting variable capacitance Cv4, variable capacitance adjustment circuit 12 for adjusting variable capacitance Cv5, variable capacitance adjustment circuit 12 for adjusting variable capacitance Cv6, variable capacitance adjustment circuit 12 for adjusting variable capacitance Cv7, and variable capacitance adjustment circuit 12 for adjusting variable capacitance Cv8.

Excitation current detection circuit 13 detects an excitation current that flows through excitation inductances Lm1 and Lm2. Since the input side of each of transformers T1 and T2 is a parallel circuit and the output side of each of transformers T1 and T2 is a series circuit, the excitation current of each phase is calculated using the half of an output current (it should be noted that strictly speaking, a ratio between the number of windings of transformer T1 and the number of windings of transformer T2 is also taken into consideration when the excitation current is calculated). Specifically, an excitation current that flows through excitation inductance Lm1 can be obtained by subtracting the half of an output current from transformers T1 and T2 from an input current to transformer T1 that flows along the path (the path in which capacitor Cr1 is provided) connecting node N1 and the primary winding of transformer T1. Likewise, an excitation current that flows through excitation inductance Lm2 can be obtained by subtracting the half of an output current from transformers T1 and T2 from an input current to transformer T1 that flows along the path (the path in which capacitor Cr2 is provided) connecting Node N1a and the primary winding of transformer T2. For this reason, excitation current detection circuit 13 may detect an excitation current by, for example, detecting an input current to transformers T1 and T2 as well as an output current from transformers T1 and T2.

Microcomputer 11 determines whether to decrease, increase, or keep the capacitance values of variable capacitances Cv5 and Cv6 based on the detection result obtained by ZVS detection circuit Z6, and determines whether to decrease, increase, or keep the capacitance values of variable capacitances Cv7 and Cv8 based on the detection result obtained by ZVS detection circuit Z8.

For example, based on the detection result obtained by ZVS detection circuit Z6, microcomputer 11 controls the capacitance value of variable capacitance Cv6 to turn on switch Q6 when a voltage across switch Q6 to which variable capacitance Cv6 is connected is a predetermined threshold voltage or lower, and controls the capacitance value of variable capacitance Cv5 to turn on switch Q5 when a voltage across switch Q5 to which variable capacitance Cv5 is connected is a predetermined threshold voltage or lower. Based on a detection result obtained by ZVS detection circuit Z8, microcomputer 11 also controls the capacitance value of variable capacitance Cv8 to turn on switch Q8 when a voltage across switch Q8 to which variable capacitance Cv8 is connected is a predetermined threshold voltage or lower, and controls the capacitance value of variable capacitance Cv7 to turn on switch Q7 when a voltage across switch Q7 to which variable capacitance Cv7 is connected is a predetermined threshold voltage or lower.

For example, ZVS detection circuit Z6 has functions of a comparator that compares a voltage across switch Q6 and a predetermined threshold voltage, outputs 1 to microcomputer 11 when the voltage across switch Q6 is higher than the predetermined threshold voltage, and outputs 0 to microcomputer 11 when the voltage across switch Q6 is the predetermined threshold voltage or lower. For example, ZVS detection circuit Z8 has functions of a comparator that compares a voltage across switch Q8 and a predetermined threshold voltage, outputs 1 to microcomputer 11 when the voltage across switch Q8 is higher than the predetermined threshold voltage, and outputs 0 to microcomputer 11 when the voltage across switch Q8 is the predetermined threshold voltage or lower.

Microcomputer 11 determines the output pattern of ZVS detection circuit Z6 in dead time when switches Q5 and Q6 are both turned off when switches Q5 and Q6 repeat being turned on and off alternately, and determines the output pattern of ZVS detection circuit Z8 in dead time when switches Q7 and Q8 are both turned off when switches Q7 and Q8 repeat being turned on and off alternately. Specifically, microcomputer 11 determines whether the output pattern of each of ZVS detection circuits Z6 and Z8 in the dead time is a first pattern, a second pattern, or an OK pattern.

When the output pattern of ZVS detection circuit Z6 is the first pattern, i.e., when the voltage across switch Q6 is constantly higher than the predetermined threshold voltage, microcomputer 11 controls the capacitance values of variable capacitances Cv5 and Cv6 to decrease the capacitance values of variable capacitances Cv5 and Cv6. When the output pattern of ZVS detection circuit Z8 is the first pattern, i.e., when the voltage across switch Q8 is constantly higher than the predetermined threshold voltage, microcomputer 11 controls the capacitance values of variable capacitances Cv7 and Cv8 to decrease the capacitance values of variable capacitances Cv7 and Cv8.

When the output pattern of ZVS detection circuit Z6 is the second pattern, i.e., when the voltage across switch Q6 increases again to be higher than the predetermined threshold voltage after changing from the state of being higher than the predetermined threshold voltage to the state of being the predetermined threshold voltage or lower, microcomputer 11 controls the capacitance values of variable capacitances Cv5 and Cv6 to increase the capacitance values of variable capacitances Cv5 and Cv6. When the output pattern of ZVS detection circuit Z8 is the second pattern, i.e., when the voltage across switch Q8 increases again to be higher than the predetermined threshold voltage after changing from the state of being higher than the predetermined threshold voltage to the state of being the predetermined threshold voltage or lower, microcomputer 11 controls the capacitance values of variable capacitances Cv7 and Cv8 to increase the capacitance values of variable capacitances Cv7 and Cv8.

When the output pattern of ZVS detection circuit Z6 is the OK pattern, i.e., when the voltage across switch Q6 is changed from the state of being higher than the predetermined threshold voltage to the state of being the predetermined threshold voltage or lower, microcomputer 11 controls the capacitance values of variable capacitances Cv5 and Cv6 to keep the capacitance values of variable capacitances Cv5 and Cv6. When the output pattern of ZVS detection circuit Z8 is the OK pattern, i.e., when the voltage across switch Q8 is changed from the state of being higher than the predetermined threshold voltage to the state of being the predetermined threshold voltage or lower, microcomputer 11 controls the capacitance values of variable capacitances Cv7 and Cv8 to keep the capacitance values of variable capacitances Cv7 and Cv8.

By controlling the capacitance values of variable capacitances Cv5 and Cv6, it is possible to control, by the excitation current of transformer T2, the speed of drawing electric charges accumulated in the output capacities of switches Q5 and Q6, thereby turning on switches Q5 and Q6 when the voltage across switch Q5 and the voltage across switch Q6 are each the predetermined threshold voltage or lower. By controlling the capacitance values of variable capacitances Cv7 and Cv8, it is possible to control, by the excitation current of transformer T2, also the speed of drawing electric charges accumulated in the output capacities of switches Q7 and Q8, thereby turning on switches Q7 and Q8 when the voltage across switch Q7 and the voltage across switch Q8 are each the predetermined threshold voltage or lower.

When it is detected that ZVS of switches Q2, Q4, Q6, and Q8 is no longer performed, for instance, in the case where a load fluctuates, an input voltage fluctuates, or a switching frequency fluctuates, power conversion device 2a, like power conversion device 2, can control the capacitance values of variable capacitances Cv1, Cv2, Cv3, Cv4, Cv5, Cv6, Cv7, and Cv8 so that ZVS of switches Q1, Q2, Q3, Q4, Q5, Q6, Q7, and Q8 is performed.

It should be noted that in power conversion device 2a, circuits are connected in parallel, and the output capacities of the switches or the excitation inductances of the transformers may vary among the circuits. In this case, when variable capacitances Cv1, Cv2, Cv3, Cv4, Cv5, Cv6, Cv7, and Cv8 are controlled in the same manner, one of a combination of switches Q1, Q2, Q3, and Q4 or a combination of switches Q5, Q6, Q7, and Q8 may remain to be in a hard switching state. This is because the output capacities of the switches or the excitation inductances of the transformers are varied among the circuits, and therefore, the speed of drawing electric charges accumulated in the output capacities also varies depending on the excitation current.

However, even when the output capacities of the switches or the excitation inductances of the transformers are varied among the circuits, power conversion device 2a can achieve soft switching. This is because power conversion device 2a includes one or more ZVS detection circuits for each of the circuits. This is specifically because: the capacitance values of variable capacitances Cv1 and Cv2 are adjusted to values in accordance with a detection result obtained by ZVS detection circuit Z2 so that switches Q1 and Q2 are controlled to perform soft switching; the capacitance values of variable capacitances Cv3 and Cv4 are adjusted to values in accordance with a detection result obtained by ZVS detection circuit Z4 so that switches Q3 and Q4 are controlled to perform soft switching; the capacitance values of variable capacitances Cv5 and Cv6 are adjusted to values in accordance with a detection result obtained by ZVS detection circuit Z6 so that switches Q5 and Q6 are controlled to perform soft switching; and the capacitance values of variable capacitances Cv7 and Cv8 are adjusted to values in accordance with a detection result obtained by ZVS detection circuit Z8 so that switches Q7 and Q8 are controlled to perform soft switching.

Thus, even when the output capacities of the switches or the excitation inductances of the transformers are varied among the circuits, power conversion device 2a includes ZVS detection circuits Z2, Z4, Z6, and Z8, and each of a combination of switches Q1 and Q2, a combination of switches Q3 and Q4, a combination of switches Q5 and Q6, and a combination of switches Q7 and Q8 is controlled so that soft switching can be performed, power conversion device 2a can achieve soft switching.

For example, switch Q5, switch Q6, switch Q7, and switch Q8 have an approximately same parameter, and each of the parasitic capacities (capacitors C5, C6, C7, and C8) has an approximately same capacitance value. For this reason, a ZVS detection circuit may be provided only in any one of switches Q5, Q6, Q7, and Q8 in a full-bridge configuration. In this case, microcomputer 11 may control the capacitance values of variable capacitances Cv5, Cv6, Cv7, and Cv8 based on a detection result obtained by the ZVS detection circuit provided in any one of switches Q5, Q6, Q7, and Q8. This is because if the hard switching state of any of switches Q5, Q6, Q7, and Q8 can be detected, it is possible to estimate that the other three switches are also in a hard switching state, and by controlling the capacitance values of variable capacitances Cv5, Cv6, Cv7, and Cv8 in the same manner, it is possible to reset the hard switching state of switches Q5, Q6, Q7, and Q8.

Even when a ZVS detection circuit is provided in any one of switches Q1, Q2, Q3, and Q4 and in any of switches Q5, Q6, Q7, and Q8, for example, power conversion device 2a can achieve soft switching. This is because even when the output capacities of the switches or the excitation inductances of the transformers are varied among circuits, power conversion device 2a includes a ZVS detection circuit in each circuit and each of a combination of switches Q1, Q2, Q3, and Q4 and a combination of switches Q5, Q6, Q7, and Q8 is controlled so that soft switching can be performed.

### Other Embodiments

As described above, the embodiments have been described as examples of techniques according to the present disclosure. The techniques according to the present disclosure, however, are not limited to these examples and are applicable to an embodiment to which changes, replacement, addition, and omission are made where necessary. For example, variations as described below are included in the embodiments of the present disclosure.

For example, each of the above embodiments has described an example in which the power conversion device includes resonance capacitors (capacitors Cr1 and Cr2), but the power conversion device need not include resonance capacitors. In other words, the power conversion device does not need to be an LLC converter.

Although each of the above embodiments has described an example in which the power conversion device includes a control circuit (microcomputer 11), the power conversion device need not include a control circuit.

Although each of the above embodiments has described an example in which the power conversion device includes variable capacitance adjustment circuit 12, the power conversion device need not include variable capacitance adjustment circuit 12.

Although each of the above embodiments has described an example in which the power conversion device includes excitation current detection circuit 13, the power conversion device need not include excitation current detection circuit 13.

Although each of the above embodiments has described an example in which the power conversion device includes input voltage detection circuit 14, the power conversion device need not include input voltage detection circuit 14.

Although each of the above embodiments has described an example in which the power conversion device includes output voltage detection circuit 15, the power conversion device need not include output voltage detection circuit 15.

Each of the above embodiments has described an example in which a ZVS detection circuit is provided in one of a High-side switch (e.g., switch Q1, Q3, Q5, or Q7) or a Low-side switch (e.g., switch Q2, Q4, Q6, or Q8), but a ZVS detection circuit may be provided in both of the High-side switch and the Low-side switch. In this case, the ZVS detection circuit provided in the High-side switch detects whether the High-side switch is performing ZVS, based on a voltage across the High-side switch, and the ZVS detection circuit provided in the Low-side switch may detect whether the Low-side switch is performing ZVS, based on a voltage across the Low-side switch.

For example, the present disclosure can be implemented not only as a power conversion device, but also as a power conversion device control method that includes steps (processes) performed by a control circuit (e.g., microcomputer 11) included in the power conversion device.

For example, the steps in the power conversion device control method may be executed by a computer (computer system). The present disclosure can be implemented as a program for causing the computer to execute the steps included in the power conversion device control method.

Moreover, the present disclosure can be implemented as a non-transitory computer-readable recording medium such as a CD-ROM on which the program is recorded.

When the present disclosure is implemented by a program (software), each of the steps is executed by the program executed by utilizing hardware resources of, for instance, a CPU, memory, and an input/output circuit in the computer. In other words, each step is executed by the CPU obtaining and calculating data from, for instance, the memory or the input/output circuit, or outputting a calculation result to the memory or the input/output circuit.

Each of the elements included in the power conversion device according to the above embodiment may be implemented as a dedicated or general circuit.

Each of the elements included in the power conversion device according to the above embodiment may be implemented as a large scale integration (LSI) circuit that is an integrated circuit (IC).

The elements need not be implemented as LSIs but may be implemented as dedicated circuits or general-purpose processors. A field programmable gate array (FPGA) that can be programmed or a reconfigurable processor that can reconfigure the connection or configuration of circuit cells in the LSI may be used.

Furthermore, if other technologies that improve upon or are derived from semiconductor technology enable integration technology to replace LSI circuits, then naturally it is also possible to integrate the elements included in the power conversion device using that technology.

Other embodiments obtained by various modifications to the embodiments which may be conceived by those skilled in the art, and embodiments achieved by arbitrarily combining elements and functions described in each of the embodiments are also included in the scope of the present disclosure so long as they do not depart from the essence of the present disclosure.

### (Supplementary Notes)

Based on the embodiments described above, the following techniques are disclosed.

### (Technique 1)

A power conversion device comprising:
a first switch provided on a first path connecting an input terminal and a ground terminal;
a second switch provided on the first path and connected to the first switch in series;
a transformer including a primary winding and a secondary winding, the primary winding being connected to a first node between the first switch and the second switch on the first path;
a first variable capacitance connected in parallel to one switch out of the first switch and the second switch; and
a first zero volt switching detection circuit that detects whether the first switch and the second switch are performing zero volt switching, based on a voltage across the one switch out of the first switch and the second switch, wherein
a capacitance value of the first variable capacitance is a value in accordance with a detection result obtained by the first zero volt switching detection circuit.

With this, the capacitance value of the first variable capacitance is controlled in accordance with a detection result of whether the switch to which the first variable capacitance is connected is performing zero volt switching. In other words, when it is detected that zero volt switching is no longer performed in the case where, for instance, a load fluctuates, an input voltage fluctuates, or a switching frequency fluctuates, it is possible to control the capacitance value of the first variable capacitance so that zero volt switching is performed. Accordingly, it is possible to provide an improved power conversion device capable of achieving soft switching.

### (Technique 2)

The power conversion device according to Technique 1 further comprising:
a capacitor connected between the first node and the primary winding.

Thus, the power conversion device may be an LLC converter, and it is possible to provide an improved LLC converter capable of performing low-noise high-efficiency operations and achieving soft switching.

### (Technique 3)

The power conversion device according to Technique 1 or 2, further comprising:
a control circuit that controls the capacitance value of the first variable capacitance based on the detection result obtained by the first zero volt switching detection circuit.

Thus, the power conversion device may have a function to control the capacitance value of the first variable capacitance.

### (Technique 4)

The power conversion device according to Technique 3, wherein
based on the detection result obtained by the first zero volt switching detection circuit, the control circuit controls the capacitance value of the first variable capacitance to turn on the one switch out of the first switch and the second switch when the voltage across the one switch is a predetermined threshold voltage or lower.

By controlling the capacitance value of the first variable capacitance, it is possible to control the speed of drawing electric charges accumulated in the output capacity of the switch to which the first variable capacitance is connected, thereby turning on the switch when a voltage across the switch is a predetermined threshold voltage or lower (i.e., zero volt switching can be achieved).

### (Technique 5)

The power conversion device according to Technique 4, wherein
in dead time during which the first switch and the second switch are turned off, when the voltage across the one switch out of the first switch and the second switch is constantly higher than the predetermined threshold voltage, the control circuit controls the capacitance value of the first variable capacitance to decrease the capacitance value of the first variable capacitance.

In dead time, when the voltage across the switch to which the first variable capacitance is connected is constantly higher than the predetermined threshold voltage, the output capacity of the switch is large and the speed of drawing electric charges accumulated in the output capacity decreases. Accordingly, in this case, it is possible to increase the speed of drawing the electric charges accumulated in the output capacity by decreasing the capacitance value of the first variable capacitance, thereby bringing the voltage across the switch to the predetermined threshold voltage or lower at the timing when the dead time ends. It is therefore possible to turn on the switch when the voltage across the switch is the predetermined threshold voltage or lower.

### (Technique 6)

The power conversion device according to Technique 4 or 5, wherein
in dead time during which the first switch and the second switch are turned off, when the voltage across the one switch out of the first switch and the second switch increases again to be higher than the predetermined threshold voltage after changing from a state of being higher than the predetermined threshold voltage to a state of being the predetermined threshold voltage or lower, the control circuit controls the capacitance value of the first variable capacitance to increase the capacitance value of the first variable capacitance.

In dead time, when the voltage across the switch to which the first variable capacitance is connected increases again to be higher than the predetermined threshold voltage after changing from the state of being higher than the predetermined threshold voltage to the state of being the predetermined threshold voltage or lower, the output capacity of the switch is small and the speed of drawing electric charges accumulated in the output capacity increases. Accordingly, in this case, it is possible to decrease the speed of drawing the electric charges accumulated in the output capacity by increasing the capacitance value of the first variable capacitance, thereby inhibiting the voltage across the switch from increasing again to be higher than the predetermined threshold voltage after changing from the state of being the predetermined threshold voltage or lower at the timing when the dead time ends. It is therefore possible to turn on the switch when the voltage across the switch is the predetermined threshold voltage or lower.

### (Technique 7)

The power conversion device according to any one of Techniques 3 to 6, further comprising:
an excitation current detection circuit that detects an excitation current that flows through the transformer, wherein
the control circuit controls the capacitance value of the first variable capacitance based on the detection result obtained by the first zero volt switching detection circuit and a detection result obtained by the excitation current detection circuit.

Since an excitation current is an element that can draw electric charges accumulated in the output capacity of the switch to which the first variable capacitance is connected and that greatly affects the achievement of soft switching, soft switching can be achieved with more accuracy by using also a result of detecting an excitation current itself.

### (Technique 8)

The power conversion device according to any one of Techniques 3 to 7, further comprising:
an input voltage detection circuit that detects a voltage of the input terminal, wherein
the control circuit controls the capacitance value of the first variable capacitance based on the detection result obtained by the first zero volt switching detection circuit and a detection result obtained by the input voltage detection circuit.

Since an input voltage has a correlation with the output capacities of the switches as well as an excitation current that greatly affects the achievement of soft switching, soft switching can be achieved with more accuracy by using also a result of detecting an input voltage itself.

### (Technique 9)

The power conversion device according to any one of Techniques 3 to 8, wherein
the secondary winding is connected to a rectifier circuit,
the power conversion device further comprises an output voltage detection circuit that detects a voltage of an output terminal connected to the rectifier circuit, and
the control circuit controls the capacitance value of the first variable capacitance based on the detection result obtained by the first zero volt switching detection circuit and a detection result obtained by the output voltage detection circuit.

Since an output voltage has a correlation with a switching frequency, and the switching frequency has a correlation with an excitation current that greatly affects the achievement of soft switching, soft switching can be achieved with more accuracy by using also a result of detecting an output voltage itself.

### (Technique 10)

The power conversion device according to any one of Techniques 1 to 9, wherein
the first switch, the second switch, the transformer, the first variable capacitance, and the first zero volt switching detection circuit configure a primary-side circuit,
the power conversion device includes a plurality of primary-side circuits each of which is the primary-side circuit,
the plurality of primary-side circuits are connected to each other in parallel, and
a switching frequency of the first switch is same as a switching frequency of the second switch in the plurality of primary-side circuits.

When it is detected that zero volt switching is no longer performed in the case where the output capacities of switches in circuits are varied in such a power conversion device in which primary-side circuits are connected in parallel, the capacitance value of the first variable capacitance can be controlled so that zero volt switching is performed. Accordingly, even when the output capacities of switches in circuits are varied in a power conversion device in which primary-side circuits are connected in parallel, soft switching can be achieved.

### (Technique 11)

The power conversion device according to any one of Techniques 1 to 10, further comprising:
a second variable capacitance connected in parallel to an other switch out of the first switch and the second switch, wherein
the capacitance value of the first variable capacitance and a capacitance value of the second variable capacitance are values in accordance with the detection result obtained by the first zero volt switching detection circuit.

### (Technique 12)

The power conversion device according to any one of Techniques 1 to 9, further comprising:
a third switch provided on a second path connecting the input terminal and the ground terminal, the second path being different from the first path;
a fourth switch provided on the second path and connected to the third switch in series; and
a second variable capacitance connected in parallel to one switch out of the third switch and the fourth switch, wherein
the primary winding is connected between the first node and a second node between the third switch and the fourth switch on the second path.

Thus, even when the primary-side of the power conversion device has a full-bridge configuration, it is possible to provide an improved power conversion device capable of achieving soft switching.

### (Technique 13)

The power conversion device according to Technique 12, further comprising:
a second zero volt switching detection circuit that detects whether the third switch and the fourth switch are performing zero volt switching, based on a voltage across the one switch out of the third switch and the fourth switch.

Thus, a zero volt switching detection circuit may be provided in each arm of a full-bridge circuit.

### (Technique 14)

The power conversion device according to Technique 12 or 13, wherein
the first switch, the second switch, the third switch, the fourth switch, the transformer, the first variable capacitance, the second variable capacitance, and the first zero volt switching detection circuit configure a primary-side circuit,
the power conversion device comprises a plurality of primary-side circuits each of which is the primary-side circuit,
the plurality of primary-side circuits are connected to each other in parallel, and
a switching frequency of the first switch, a switching frequency of the second switch, a switching frequency of the third switch, and a switching frequency of the fourth switch in the plurality of primary-side circuits are same.

When it is detected that zero volt switching is no longer performed in the case where the output capacities of switches in circuits are varied in such a power conversion device in which primary-side circuits are connected in parallel, the capacitance value of the second variable capacitance can be controlled so that zero volt switching is performed. Accordingly, even when the output capacities of switches in circuits are varied in a power conversion device in which primary-side circuits are connected in parallel, soft switching can be achieved.

### (Technique 15)

The power conversion device according to any one of Techniques 12 to 14, further comprising:
a third variable capacitance connected in parallel to an other switch out of the third switch and the fourth switch, wherein
a capacitance value of the third variable capacitance and a capacitance value of the fourth variable capacitance are values in accordance with a detection result obtained by a second zero volt switching detection circuit.

### (Technique 16)

The power conversion device according to any one of Techniques 12 to 15, further comprising:
a fourth variable capacitance connected in parallel to an other switch out of the first switch and the second switch, wherein
a capacitance value of the first variable capacitance and a capacitance value of the fourth variable capacitance are values in accordance with the detection result obtained by the first zero volt switching detection circuit.

### (Technique 17)

The power conversion device according to any one of Techniques 1 to 16, wherein
the first variable capacitance includes a control terminal for adjusting the capacitance value of the first variable capacitance, and
the capacitance value of the first variable capacitance is a value in accordance with an applied voltage to the control terminal.

With this, by controlling an applied voltage to the control terminal of the first variable capacitance, the capacitance value of the first variable capacitance can be controlled.

### (Technique 18)

The power conversion device according to any one of Techniques 1 to 16, wherein
the first variable capacitance includes: a plurality of capacitors whose capacitance values are different; and one or more switches that switch a combination of the plurality of capacitors, and
the capacitance value of the first variable capacitance is a value in accordance with a combination of the plurality of capacitors determined by control of switching the one or more switches.

With this, by controlling switching of one or more switches of the first variable capacitance, the capacitance value of the first variable capacitance can be controlled.

### INDUSTRIAL APPLICABILITY

The present disclosure is applicable to, for instance, power conversion devices such as LLC converters.

### REFERENCE SIGNS LIST

1, 1a, 2, 2a power conversion device
11 microcomputer
12 variable capacitance adjustment circuit
13 excitement current detection circuit
14 input voltage detection circuit
15 output voltage detection circuit
101 primary-side circuit
101a primary-side circuit
102 primary-side circuit
102a primary-side circuit
C1, C2, C3, C4, C5, C6, C7, C8, C10, C11, C12, C20, Cr1, Cr2 capacitor
Cv1, Cv2, Cv3, Cv4, Cv5, Cv6, Cv7, Cv8 variable capacitance
D1, D2, D3, D4, D5, D6, D7, D8 diode
D10, D20 rectifier circuit
L11 inductor
Lm1, Lm2 excitation inductance
Lr1, Lr2, Lr10, Lr20 leakage inductance
N1, N1a, N2, N2a node
P1, P1a, P2, P2a path
Q1, Q2, Q3, Q4, Q5, Q6, Q7, Q8 switch
T1, T2 transformer
Tid1, Tid2 ideal transformer
t1, t2, t3, t4 terminal
Z1, Z2, Z4, Z5, Z6, Z8 zero volt switching (ZVS) detection circuit

1. A power conversion device comprising:
a first switch provided on a first path connecting an input terminal and a ground terminal;
a second switch provided on the first path and connected to the first switch in series;
a transformer including a primary winding and a secondary winding, the primary winding being connected to a first node between the first switch and the second switch on the first path;
a first variable capacitance connected in parallel to one switch out of the first switch and the second switch; and
a first zero volt switching detection circuit that detects whether the first switch and the second switch are performing zero volt switching, based on a voltage across the one switch out of the first switch and the second switch, wherein
a capacitance value of the first variable capacitance is a value in accordance with a detection result obtained by the first zero volt switching detection circuit.

2. The power conversion device according to claim 1, further comprising:
a capacitor connected between the first node and the primary winding.

3. The power conversion device according to claim 1, further comprising:
a control circuit that controls the capacitance value of the first variable capacitance based on the detection result obtained by the first zero volt switching detection circuit.

4. The power conversion device according to claim 3, wherein
based on the detection result obtained by the first zero volt switching detection circuit, the control circuit controls the capacitance value of the first variable capacitance to turn on the one switch out of the first switch and the second switch when the voltage across the one switch is a predetermined threshold voltage or lower.

5. The power conversion device according to claim 4, wherein
in dead time during which the first switch and the second switch are turned off, when the voltage across the one switch out of the first switch and the second switch is constantly higher than the predetermined threshold voltage, the control circuit controls the capacitance value of the first variable capacitance to decrease the capacitance value of the first variable capacitance.

6. The power conversion device according to claim 4, wherein
in dead time during which the first switch and the second switch are turned off, when the voltage across the one switch out of the first switch and the second switch increases again to be higher than the predetermined threshold voltage after changing from a state of being higher than the predetermined threshold voltage to a state of being the predetermined threshold voltage or lower, the control circuit controls the capacitance value of the first variable capacitance to increase the capacitance value of the first variable capacitance.

7. The power conversion device according to claim 3, further comprising:
an excitation current detection circuit that detects an excitation current that flows through the transformer, wherein
the control circuit controls the capacitance value of the first variable capacitance based on the detection result obtained by the first zero volt switching detection circuit and a detection result obtained by the excitation current detection circuit.

8. The power conversion device according to claim 3, further comprising:
an input voltage detection circuit that detects a voltage of the input terminal, wherein
the control circuit controls the capacitance value of the first variable capacitance based on the detection result obtained by the first zero volt switching detection circuit and a detection result obtained by the input voltage detection circuit.

9. The power conversion device according to claim 3, wherein
the secondary winding is connected to a rectifier circuit,
the power conversion device further comprises an output voltage detection circuit that detects a voltage of an output terminal connected to the rectifier circuit, and
the control circuit controls the capacitance value of the first variable capacitance based on the detection result obtained by the first zero volt switching detection circuit and a detection result obtained by the output voltage detection circuit.

10. The power conversion device according to claim 1, wherein
the first switch, the second switch, the transformer, the first variable capacitance, and the first zero volt switching detection circuit configure a primary-side circuit,
the power conversion device includes a plurality of primary-side circuits each of which is the primary-side circuit,
the plurality of primary-side circuits are connected to each other in parallel, and
a switching frequency of the first switch is same as a switching frequency of the second switch in the plurality of primary-side circuits.

11. The power conversion device according to claim 1, further comprising:
a second variable capacitance connected in parallel to an other switch out of the first switch and the second switch, wherein
the capacitance value of the first variable capacitance and a capacitance value of the second variable capacitance are values in accordance with the detection result obtained by the first zero volt switching detection circuit.

12. The power conversion device according to claim 1, further comprising:
a third switch provided on a second path connecting the input terminal and the ground terminal, the second path being different from the first path;
a fourth switch provided on the second path and connected to the third switch in series; and
a second variable capacitance connected in parallel to one switch out of the third switch and the fourth switch, wherein
the primary winding is connected between the first node and a second node between the third switch and the fourth switch on the second path.

13. The power conversion device according to claim 12, further comprising:
a second zero volt switching detection circuit that detects whether the third switch and the fourth switch are performing zero volt switching, based on a voltage across the one switch out of the third switch and the fourth switch.

14. The power conversion device according to claim 12, wherein
the first switch, the second switch, the third switch, the fourth switch, the transformer, the first variable capacitance, the second variable capacitance, and the first zero volt switching detection circuit configure a primary-side circuit,
the power conversion device comprises a plurality of primary-side circuits each of which is the primary-side circuit,
the plurality of primary-side circuits are connected to each other in parallel, and
a switching frequency of the first switch, a switching frequency of the second switch, a switching frequency of the third switch, and a switching frequency of the fourth switch in the plurality of primary-side circuits are same.

15. The power conversion device according to claim 12, further comprising:
a third variable capacitance connected in parallel to an other switch out of the third switch and the fourth switch, wherein
a capacitance value of the second variable capacitance and a capacitance value of the third variable capacitance are values in accordance with a detection result obtained by a second zero volt switching detection circuit.

16. The power conversion device according to claim 15, further comprising:
a fourth variable capacitance connected in parallel to an other switch out of the first switch and the second switch, wherein
a capacitance value of the first variable capacitance and a capacitance value of the fourth variable capacitance are values in accordance with the detection result obtained by the first zero volt switching detection circuit.

17. The power conversion device according to claim 1, wherein
the first variable capacitance includes a control terminal for adjusting the capacitance value of the first variable capacitance, and
the capacitance value of the first variable capacitance is a value in accordance with an applied voltage to the control terminal.

18. The power conversion device according to claim 1, wherein
the first variable capacitance includes: a plurality of capacitors whose capacitance values are different; and one or more switches that switch a combination of the plurality of capacitors, and
the capacitance value of the first variable capacitance is a value in accordance with a combination of the plurality of capacitors determined by control of switching the one or more switches.
